(19) United States
(12) Patent Application Publication
(10) Pub. No.: US 2025/0329273 A1
(43) Pub. Date: Oct. 23, 2025

(54) PRODUCT SAMPLE DISPLAY SYSTEM

(71) Applicant: R & R PRODUCT, INC., Danville, IN (US)

(72) Inventor: Jeffrey R. FUEHRER, Danville, IN (US)

(73) Assignee: R & R Products, Inc., Danville, IN (US)

(21) Appl. No.: 19/257,173

(22) Filed: Jul. 1, 2025

Related U.S. Application Data
(63) Continuation-in-part of application No. 18/820,947, filed on Aug. 30, 2024.
(63) Continuation-in-part of application No. 18/417,620, filed on Jan. 19, 2024.
Application No. 18/417,620 is a continuation-in-part of application No. 17/835,333, filed on Jun. 8, 2022, now Pat. No. 12,112,659.
(60) Provisional application No. 63/208,802, filed on Jun. 9, 2021.
(60) Provisional application No. 63/236,793, filed on Aug. 25, 2021.
(60) Provisional application No. 63/321,789, filed on Mar. 21, 2022.

(51) Int. Cl. G09F 5/00

(52) U.S. Cl. CPC G09F 5/00

(57) ABSTRACT

Product sample display system with wing support brackets at seven heights to accommodate sample displays of any size or from different manufacturers. Wing support brackets include notches on opposing sides so they may be inserted or removed without disassembling the system and to limit their movement after installation.

### CROSS REFERENCE TO RELATED APPLICATIONS

This application is a continuation in part of both: (a) U.S. application Ser. No. 18/417,620 filed 19 Jan. 2024, which is a divisional of application Ser. No. 17/835,333 filed Jun. 8, 2022, now U.S. Pat. No. 12,112,659; and (b) U.S. application Ser. No. 18/417,620 which is a continuation of application Ser. No. 17/835,333 filed Jun. 8, 2022, now U.S. Pat. No. 12,112,659. Application Ser. No. 18/417,620 claims the benefit of U.S. Provisional Application Nos. 63/208,802 filed Jun. 9, 2021, 63/236,793 filed Aug. 25, 2021 and 63/321,789 filed Mar. 21, 2022. This application also claims the benefit of provisional application 63/740,601 filed Dec. 31, 2024.

### FIELD OF THE INVENTION

The present invention relates to a product sample display system and method.

### BACKGROUND

Many types of building materials and information such as carpet, wood flooring, laminate, vinyl, ceramic, tiles, rugs, other floor covering products, wall-paper, paneling, paint, cabinet doors, shingles and roofing products, as well as associated marketing information, pricing, etc., are displayed on loose samples or on page or board-type displays or rack and wing displays. These displays can be made of, for example, card stock, wrapped card stock, hardboard, styrene, formed or molded plastic products, wood, metal, or other materials. One or more wings holding such samples are typically attached to a display fixture or rack, including but not limited to, floor-standing or wall-mounted support devices using a short pin-long pin mounting method, rods, hinges, or other attachment means to secure the wings to the frame. The display device usually has a single array of wings, or one row of wings to a side, although in some instances, multi-tiered arrays of small wings are used.

Typically, all of the wings on the display device are approximately the same size and shape, often because the samples are supplied by a specific manufacturer that makes its wings and samples the same size. Usually, the long dimension of the wing forms the spine which is pivotally mounted to the display device. FIGS. 1 and 2 show representative prior art display systems. As is evident by these Figs., existing display systems limit the ability to display material or information on underlying wings of an array, since overlying wings of the array, typically being of about the same size and shape as the underlying wings, cover substantially all of the surface area of the underlying wings. Although a viewer typically can pivot the overlying wings out of the way to view an underlying wing, many consumers are reluctant to take time and effort to flip through an entire array to view the samples on every wing in a display. Moreover, many “impulse” buyers will not even bother to approach a display if a sample they might be interested in is hidden from view by overlying wings bearing material that they are not interested in.

Further, moving multiple wings in a display from one side to the other to display a selected wing can be difficult, because wings can be heavy and it may be necessary to move multiple wings. Existing displays also require a large and heavy base and structure because the wings themselves are heavy, the displays must be resistant to tipping over, and the displays must be able to withstand the force of the wings being pushed from one side of the display to the other. For this reason, existing display systems require a large of amount space, and in retail space, sufficient square footage is not economically available.

As noted, display systems are typically provided by product manufacturers, who also supply the wings or boards on which sample products are displayed. However, each display system usually holds only the wings or boards from the manufacturer that supplied the display system. This forces a retailer to display only models and styles of that manufacturer, even the low-volume styles that the retailer may not even stock. In addition, manufacturers regularly discontinue particular models or styles without replacing it when a new model or style. These samples must be removed from the display system, which results in unused capacity of the display system. While a retailer may prefer to populate the unused space with products of other manufacturers, the display system usually only accepts wings or displays of the manufacturer that supplied the display system. This results in suboptimal utilization of the display system by the retailer. It would be preferable to provide a universal display system that can accept wings or displays from any manufacturer, regardless of the size of the wings or displays or how they are mounted onto the manufacturer-supplied display system. Such a system would allow a retailer to display only the wings or displays that provide the best return on investment for the retailer.

A related problem is that some manufacturers routinely change the size of the samples they provide to retailers. For example, samples may be 18 inches high one year, and 24 inches high the next year. The different sizes usually cannot be displayed on the same display system due to the size difference. Thus, manufacturers continually create new versions of display systems for the new sizes, and sell those displays to the retailers. The display systems can cost thousands of dollars, and this practice forces a retailer to periodically purchase new display systems from the manufacturer if the retail wants to continue carrying that manufacturer's product line. From the manufacturer's perspective, this increases the investment the retailer has in the manufacturer's product line, and discourages the retailer from selling from a different manufacturer. However, because the old sample sizes are discontinued, the retailer must scrap the old display system which likely cost thousands of dollars. This is inefficient system. It would be desirable to provide a display system that not only accommodate samples of different sizes, but which can be easily adjusted to allocate portions of the display's capacity to different sample displays. This would eliminate the need for a retailer to purchase an entirely new display system when a manufacturer changes its sample sizes. Ideally, an improved display system will simultaneously allow samples from several different manufacturers to be displayed on the system.

Moreover, a display system should be easily configurable to allow it to hold many different sizes of samples without making significant changes to the display system. For example, a display system should allow a retailer to display in a vertical orientation either three 18-inch high samples, or two 36-inch high samples.

Some display systems include vertical threaded shafts on which support brackets or “paddles” may be mounted at desired vertical positions. The paddles may have notches or holes that fit around one or more of the vertical threaded shafts. The paddles may be held at a desired vertical positions by either nuts above and below the paddle on the threaded shafts, or by firmly welded them to the structural members of the display system. When threaded vertical shafts are used, those shafts may also be attached to top and bottom plates of a display system by nuts. If additional nuts need to be added to a threaded shaft on a display system to hold a new paddle, it is desirable to be able to add them in a way that minimizes the need to completely remove the threaded shafts from the top and/or bottom plates.

The support brackets or paddles may comprise a series of holes or prongs along an edge, and each hole or prong may receive a sample or wing that can pivot with respect to the display. Because samples or wings can be of different widths or weights, different paddles can be provided with a different number of holes or prongs. For example, there may be eight, ten or twelve holes/prongs on a paddle. Except for the number of holes or prongs, the paddles in a display system may look identical. A person assembling a display system my inadvertently install a paddle that has the incorrect number of holes or prongs. For, example, the person may inadvertently install a paddle with eight holes, when a paddle with ten holes was desired. Thus, it would be desirable to provide a paddle in which the number of holes or prongs may be quickly and easily identified.

It is also desirable to provide a display system in which support brackets or paddles may added or removed while keeping to a minimum the amount of disassembly and re-assembly of other components of the display.

There have been multiple attempts to solve the display issues for samples. For example, U.S. Pat. No. 2,879,898 discloses a floor mounted rug display rack that includes a downwardly sloping support to allow rugs of various sizes to be displayed using one display device. Another purpose of the '898 patent is to conserve floor space with the downwardly sloping design. However, a user would still need to lift each sample to fully view the sample underneath.

U.S. Pat. No. 4,757,906 discloses a display rack for flooring samples whereby a wire rack is used to create horizontal slots to display a sample folded into a u-shape between two of the slots. However, this requires the sample to be made from a bendable material, which is not the case for many building material samples. It also only allows the viewer to see a small portion of the whole sample.

Additionally, U.S. Patent Application No. 2003/0047528 discloses a display rack with multiple board sizes that allows dealers to use overlapping displays in which the top layer is the smallest and each subsequent layer is larger and extends past the first display. While this may seem to solve some of the issues in viewing multiple wings, the user still has to flip through each wing and will eventually have to move all of the wings back to their open position which can be heavy and cumbersome.

A display system should be able to be stable enough to hold multiple wings without tipping over or collapsing. It should also be modular so that multiple systems can be placed next to each other to make efficient use of floor space.

While the options in the prior art attempt to solve a few of the issues with current display products they have multiple limitations and none are user-friendly or space-saving.

### SUMMARY OF THE INVENTION

One embodiment of the invention provides a display frame comprising multiple vertical shafts and a base; each vertical shaft having a wing support bracket that may be positioned at a selected vertical location on the shaft. The wing support brackets may be at the top, at the bottom, or at the top and bottom. The wing support brackets are vertically adjusted allow any sized display wing to be fitted into the display frame. There can also be multiple wing support brackets on a single shaft. These improvements allow wings of different heights, for instance from different manufacturers, to be held on the same display frame. They further allow groupings of wings by type (e.g., type of floor), subtype (e.g., material), color, manufacturer, etc.

Another embodiment of the present invention provides a display frame with a base and parallel vertical shafts in a curved configuration with wing stops. The wing stops limit the angle, from neutral, that each wing frame can pivot. The curved configuration may be a full or partial oval or circle with the base and support rings being full or cut to allow reconfiguration as desired to full, half, or quarter barrel configurations. The ability to use partial oval or circle base and support rings allows the display frame to be positioned around and/or adjacent to a building support column to optionally support the display structure. These improvements allow the display frame to hold more wings in a configuration that takes up less square footage. Further, the number of adjacent wings that are moved when an adjacent pair of wings is opened is limited, which allows multiple adjacent wings to be viewed by different people at different parts of the display frame at the same time. The curved configuration allows the user to use less force to move the wings since the curved arrangement limits the number of wings that must be moved simultaneously. Additionally, there is improved viewability since the adjacent wings in a non-linear display may be opened to a greater angle than in a typical linear display. In the present invention, the wings may be opened approximately 100°-150°. Finally, there is increased stability when attaching the display frame to an existing building column.

A further embodiment includes a mechanism to bias the wing frames of a display system towards a neutral position. For this embodiment, a display frame holding multiple adjacent wings includes a mechanism to bias the wing frames toward the neutral position if the wing frame is close to neutral position (e.g. ≤ 15°) or toward the open position if the wing frame is close to a not near neutral position (e.g. more than 15°). This feature eliminates the need for a salesperson to manually move the wing frames to a neutral position after a consumer has viewed a display. Further, no wing will abut an adjacent wing (when all wings are in the neutral position) so some part of each wing is viewable without having to move any wing. Finally, this allows for an increased aesthetic appearance.

A display system of the present invention may be spaced around a building support column optionally using abutting displays by attaching S brackets to abutting displays as described in FIG. 28. In this embodiment, at least two opposing sides would be equipped with wing support brackets. This may allow a smaller base with a lighter support structure that is sturdy and not likely to tip over.

Using a display system with battery-operated overhead lights can also help improve a display system. The system may be provided with multiple groups of adjacent wings having a common feature or each individual system would have a common feature. For example, the common features could include manufacturer, flooring type, flooring sub-type, color, etc. The user could have multiple sets of battery-operated lights on the same display system with each set shining a different color of light on each of the groupings. This would make it easier to locate flooring samples having a desired feature. It also allows displays to be located where a wired power source is not available or easily accessible.

Integrating a display system with QR codes for each display or wing integrated with an information provision system allows for easier shopping for the customer and eliminates a lot of unnecessary work for the seller. For example, each wing may have a barrel (display) identifier, a wing identifier, sample identifier, and a QR code. A database is provided that associates the QR code with information about the product displayed that is associated with the display identifier, wing identifier, and sample identifier. Some of the information that may be provided includes price, availability status, backorder status, discontinued status, and similar products. This database would be available via a hardware and software system that is operable to display the information associated with a scanned-in QR code. The hardware and software system may also be able to accept quoting and ordering information and generate pricing information for the product quoted or ordered. The hardware may be a smartphone, tablet, or any other hardware that is equipped with QR reader capabilities.

The system may also include a database having identifiers for multiple store locations. The system further includes a means for receiving geolocation information from the hardware used to input quoting or ordering information and a means for quoting pricing information based on the received geolocation information. These improvements eliminate the need to manually update pricing on displays, allow a consumer to receive information and quotes without the assistance of a salesperson, collects information about each consumer that scans a QR code, and allows deployment of the system in multiple locations.

Another aspect of the present invention is a system that biases the wings toward a neutral position. A display structure, not necessarily in a curved configuration, holding multiple pivotable wings may be made whereby each wing is positionable in a neutral position in which the wing does not abut or contact any adjacent wing. The structure would further include a means biasing each wing toward its neutral position. This permits easier viewing of a portion of each wing because adjacent wings are not abutting, which allows viewing of each wing. It also reduces the amount of force required to fully open and display a desired wing when all wings are in their neutral position because adjacent wings will not need to be moved as a user begins to move the desired wing to a displayed position.

A further option includes the use of a display frame holding a plurality of pivotable display wing frames with a stop means connected to the wing frame for each wing operable to limit the extent to which each wing may pivot. This reduces the amount of force required to fully open and display a desired wing because the adjacent wings can only be opened to a limited extent. This means the adjacent wings cannot put their full force on the desired wing making it lighter and easier to open. The stop means may include the point at which the wing frame hits the edge of the wing support bracket, thereby not allowing the frame to rotate any further.

Another embodiment of the present invention includes a non-neutral position holding mechanism such as a magnet, detent, or some other suitable means to hold the wing frames in a non-neutral position. The holding mechanism allows the wing to be kept in its displayed position without the user holding it open. This may be accomplished with a magnet affixed to the wing support bracket and the wing frame being comprised of a material attracted by the magnet. Another option is using a small detent in the wing support bracket with a small bulb on the wing frame that fits within the detent and is removable with a small amount of force. This improves the viewing of the wings because they will remain open and not be affected by gravity or inadvertent movement of the wing frame.

A further embodiment of the present invention may be manufactured using vertical shafts. Each vertical shaft may have a plurality of holes, or vertical wing adjustments, along its length at set intervals, such as a hole every 34″ along the length. A wing support bracket may placed over the vertical shaft and can be adjustably held in place against the vertical shaft. One option for holding the wing support bracket in place is by sliding a pin through a hole in the wing support bracket and the vertical shaft. Further, the wing support bracket may rest on a pin placed through a hole in the vertical shaft. The wing support bracket may also have wing stops that limit the extent to which the wings may open and/or magnets on the sides of the wing support bracket that hold the wing frame open.

A further embodiment comprises wing support brackets that have notches to allow them to mounted on or removed from threaded shafts at any desired vertical location. Nuts and washers may be mounted on a threaded shaft and moved to the vertical location where it is desired to mount a wing support bracket. Notches in the wing support bracket may be fitted around threaded shaft, and then secured to the shaft with the nuts and washers. Separate holds or pegs in the wing support bracket allow the wings or display of different heights to be mounted on the display system.

A further embodiment comprises a clamp having two arms with block on each arm. The combination of the clamp arms and blocks securely hold a wing or display to the clamp. The use of the clamp allows the system to hold a wing or display of virtually any manufacturer. In one embodiment, the block is provided with two perpendicular slots, each of which is offset from the midlines of the block by a different amount. By selecting the orientation of the block when placing it over an arm of clamp, it is possible to select the size of the gap between the blocks. This allows the clamp to securely hold a wing or display board regardless of the thickness of the wing or display board. This is desirable because the thickness of wings and display boards vary greatly between different manufacturers, and the ability to accommodate different widths allows virtually any wing or display board to be mounted on the display system.

### BRIEF DESCRIPTION OF THE DRAWINGS

FIG. 1 shows a representative prior art display system holding triple-height display boards in which six display boards (three on each side) are on each wing. Thus, pivoting one wing moves six display boards.

FIG. 2 shows a representative prior art display system holding upper and lower sets of display boards in which two display boards (one on each side) are on each wing. An upper wing may pivot independently the wing below it.

FIG. 3 shows a display system with multiple vertical shafts in a circular orientation and height-adjustable wing support brackets on different vertical shafts to display wings of varying heights.

FIG. 4 shows a display wing support bracket having holes or notches to attach it to vertical shafts at a desired height, and, a variety of holes or pegs to receive pivotable display wings.

FIG. 5 shows the top and central support structures of a semi-circular display system, and how display wing support brackets may be mounted on either vertical shafts or the central support structure.

FIG. 6 shows the lower part of a semi-circular display system, and how notches in display wing support brackets may be mounted on or removed from vertical shafts.

FIG. 7 a partially populated display system in which a tall wing is held by a wing support bracket at one height, and how other wing support brackets may be positioned at different heights.

FIG. 8 is a perspective view of clamp for holding a wing or display board having a multiple channels, each having left and right grooves which may receive threaded rods, and which allow washers and nuts to be removed from or added to a threaded rod while minimizing the for mounting onto a peg.

FIG. 9 is perspective view a compressive block have two perpendicular slots that are each offset from the midline of the block by a different amount. The slots may be fitted over the arms of the clamp in FIG. 8.

FIG. 10 is a top cross sectional view of a clamp of FIG. 8 having mounted on each arm a block as shown in FIG. 9 to hold thin display board.

FIG. 11 is a top cross sectional view of a clamp of FIG. 8 having mounted on each arm a block as shown in FIG. 9 to hold thick display board.

FIG. 12 is a perspective view of clamp for holding a wing or display board having a peg mounting onto a hole in a support bracket.

FIG. 13 is a perspective view of a small display wing support bracket sized to hold a single wing or display board.

FIG. 14 is a partial top cross-section view of the bottom part of a display wing mounted on display wing support bracket with two spring arms that bias display wing toward a neutral position.

FIG. 15 is a partial top cross-section view of the bottom part of a display wing mounted on display wing support bracket with two spring arms, in which the wing is pivoted to a non-neutral position and held by a magnet mounted on the bracket, and in which the magnet also acts as a stop.

FIG. 16 shows a representative display board having a QR code.

FIG. 17 is a first exemplar of the information displayed using the QR code, hardware, and software system.

FIG. 19 is a second exemplar of components of a display system including rigid support structures.

FIG. 18 is a second exemplar of the information displayed using the QR code, hardware, and software system.

FIG. 20 is a downward looking view from the middle of system showing the locations of a center area in a baseplate, rigid support structures, and threaded shafts.

FIG. 21 is a view showing a floor baseplate, legs, rigid support structures, and threaded shafts.

FIG. 22 is a view of a second exemplar of components of a display system including rigid support structures, and also showing the floor baseplate with legs with levelling mechanisms, an upper plate, and threaded shafts showing how they may be connected proximal to the legs and in which threaded shaft pairs are equally spaced.

FIG. 23 shows how multiple with wing support brackets may be mounted on at selected heights on threaded shafts, to thereby accommodate display wights of differing heights.

FIG. 24 shows two versions of display wings, one of which has pegs in one corners to fit into holes in wing support brackets.

FIG. 25 shows versions of wing support brackets having pegs and holdes for holding product display wings.

FIG. 26 shows a display system in which the upper plate holds lights that project downward toward product the area where product display wings may be positioned, and an arcuate display extending from the upper plate.

FIG. 27 shows an S connector suitable for securing adjacent threaded shafts to increase the structural integrity of the display system.

FIG. 28 shows an S connector mounted to adjacent threaded shafts.

FIG. 29 shows a bracket which may be attached to product samples to create product display wings.

FIG. 30 shows a product display wing made by a product sample with two brackets of FIG. 29 attached thereto.

FIG. 31 is a cross section of a leg of the display system having a floor levelling mechanism.

FIG. 32 is a bottom view of legs of a product display system.

FIG. 33 shows a display system having support brackets (paddles) at seven different heights, which is able to accommodate a wide variety of product samples of different heights positioned at various vertical heights.

FIG. 34 is view of a top plate of a display system having multiple channels with right and left arms, which allow the tops of threaded shafts to be temporarily removed from the top plate so washers and nuts may be added or removed to the shaft while minimizing disassembly and reassembly of the display components.

FIGS. 35a-35c show support brackets having notches at opposing side edges, eight, ten and twelve support holes or pegs, and identification cut-outs to reflect the number of holes or pegs.

FIGS. 36a-36c show how a paddle of FIGS. 35a may be secured to two threaded rods.

FIGS. 37a and 37b are show sample deck boards having handles for hanging the deck board.

FIG. 38 is a side view of deck board holder that can be held by paddles.

FIG. 39 is an end view of the deck board holder shown in FIG. 38, which shows that alternate tabs are bent to the left and right, respectively.

FIG. 40 shows the deck board holder mounted in paddles, in which the tabs on the alternate sides each hold a deck board.

FIG. 41 a column of wing support brackets (paddles) in which each bracket is permanently or semi-permanently affixed to two shafts.

FIG. 42 shows the top of a column of wing support brackets (paddles) mounted on a shaft having threads at the top of the shaft.

FIG. 43 shows a top plate or bottom plate have teardrop-shaped holes to receive the tops and bottoms of shafts.

FIG. 44 shows the bottom of a display having a bottom plate of FIG. 43 with a column of wing support brackets (paddles) secured to the teardrop-shaped holes.

### DETAILED DESCRIPTION

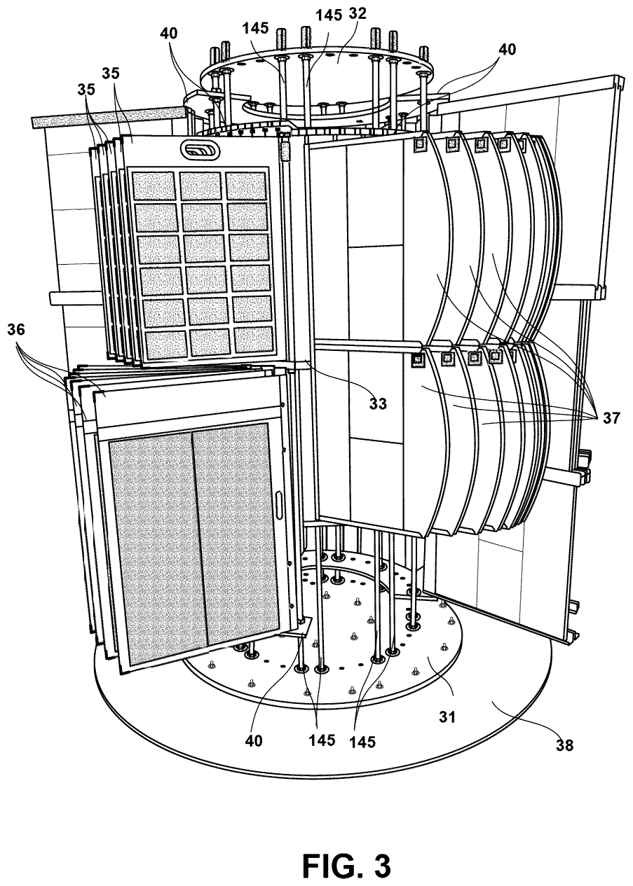

As shown in FIG. 3, disclosed is a display frame comprising multiple vertical shafts 145 that extend between a bottom support base 31, a top support 32, and an optional central support 33. In one embodiment, the vertical shafts are arranged in a circular or arcuate orientation.

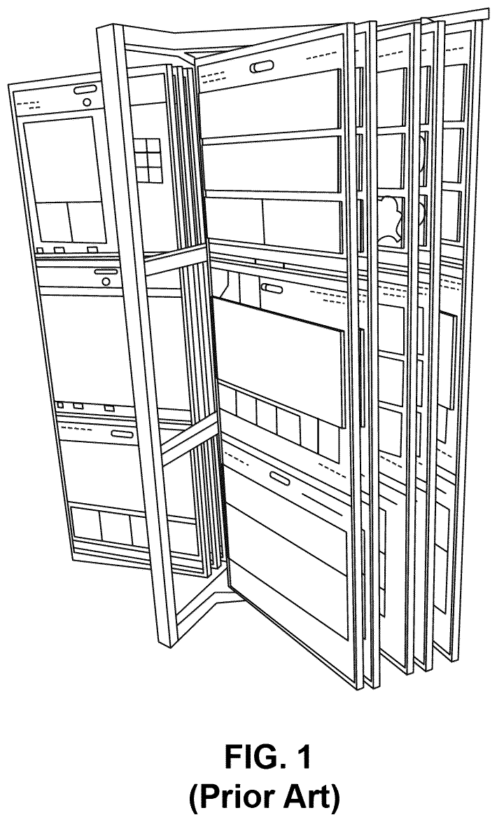

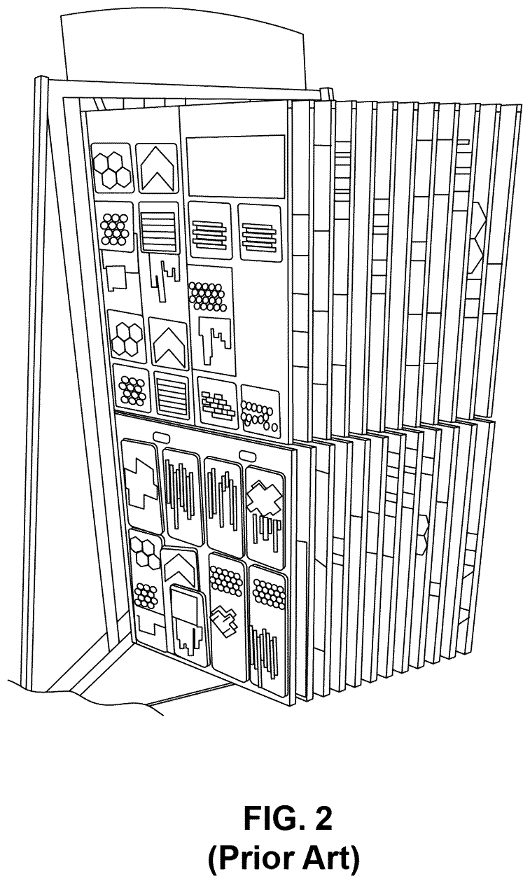

Wing support brackets 40 are mounted on the shafts, and can be positioned at any vertical point along the shafts 145. This allows the system to hold display wings 35, 36, 37 of different heights, which may be from different manufacturers. This allows the display system to be much more versatile than existing systems which typically only accommodate display wings that are the same height, as shown in FIGS. 1 and 2.

The wing support brackets 40 may be at the top, at the bottom, or at the top and bottom of the wing frames. The wing support brackets are vertically positioned on threaded shafts having nuts to set the height. The top 32, bottom 31 and central 33 supports may also serve as wing support brackets. In lieu of nuts on the shafts to hold wing support brackets, clamps may be attached to the vertical shafts to set the position of the wing support brackets. Multiple wing support brackets may be positioned on a single shaft. These improvements allow wings of different heights, for instance from different manufacturers 35, 36, 37, to be held on the same display structure. They further allow groupings of wings by type (e.g., type of floor), subtype (e.g., material), color, manufacturer, etc., as exemplified in FIG. 3.

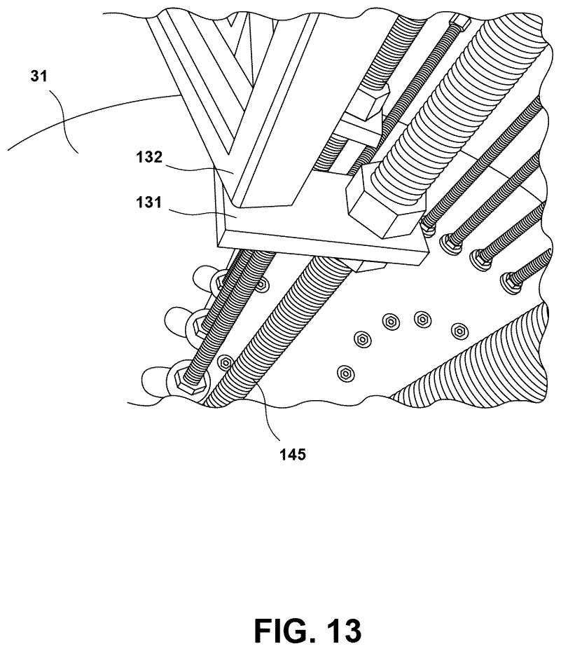

FIG. 13 is a perspective view of a small display wing support bracket 131 sized to hold a single wing or display board 132. The support bracket 131 may either have a notch or hole that receives vertical shaft 145. The wing or display board 132 may pivot on support bracket 131, either by virtue of hole in support bracket 131 that receives a peg extending from display board 132, or a peg in support bracket 131 that is inserted into a hole in display board 132. Support bracket 131 is positioned at a desired vertical location on vertical shaft 145 and is held in place by washers and nuts above and below the bracket.

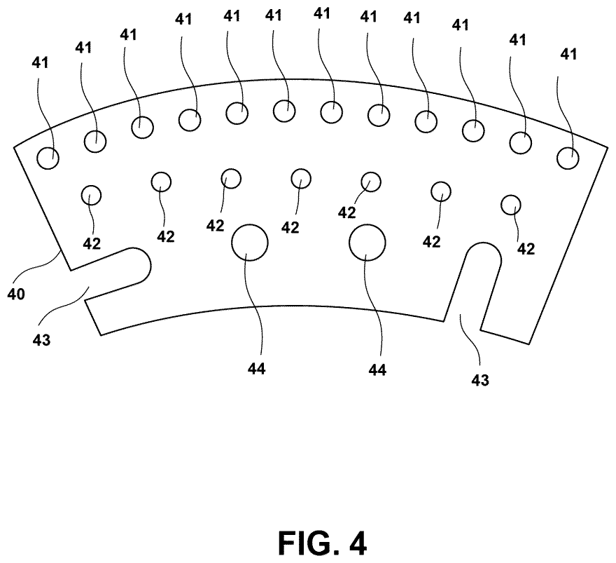

As shown in FIG. 4, To facilitate positioning the wing support brackets on the shafts, the brackets have holes 44 or notches 43 that engage the vertical shafts. If holes 44 are used, they need to be placed over the shafts as the display system is being constructed. Thus, it is preferable to use notches 45 instead. Notches 43 allow the wing support bracket to be mounted on the vertical shafts after the display system has been constructed; i.e., after the vertical shafts are mounted to the bottom support base and the top support. FIG. 4 shows a top view of such a wing support bracket 40 that has both notches 43 and holes 44.

Regardless of which option is used, wing support bracket 40 may be securely mounted to vertical shafts at a desired height by nuts and bolts positioned immediately above and below the wing support bracket 40.

In the display system shown in FIG. 3, the notched display support brackets as shown in FIG. 4 are used. The display support bracket shown in FIG. 4 has an outer row of holes 41 and an inner row of holes 42. Each of these holes can hold a display wing. A retailer may choose to use the holes 41 in an outer row for displays that are not deep (or wide), and holes 42 in an inner row for displays that are deeper. For example, in FIG. 3, the displays 35 are not as deep as the displays 36. This selection allows the outer edges of the display wings to be closer together.

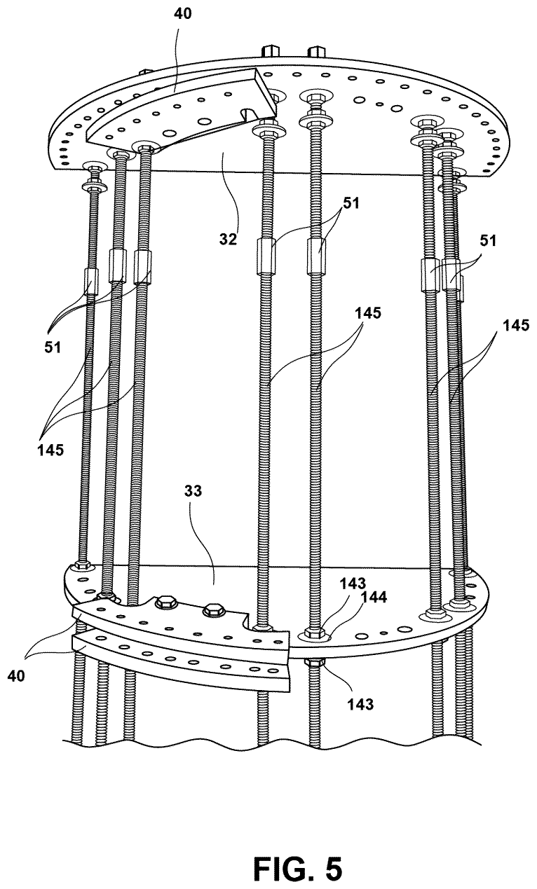

FIG. 5 shows a display system with the display wings removed, to show how the wing support brackets may be mounted on the vertical shafts at various places.

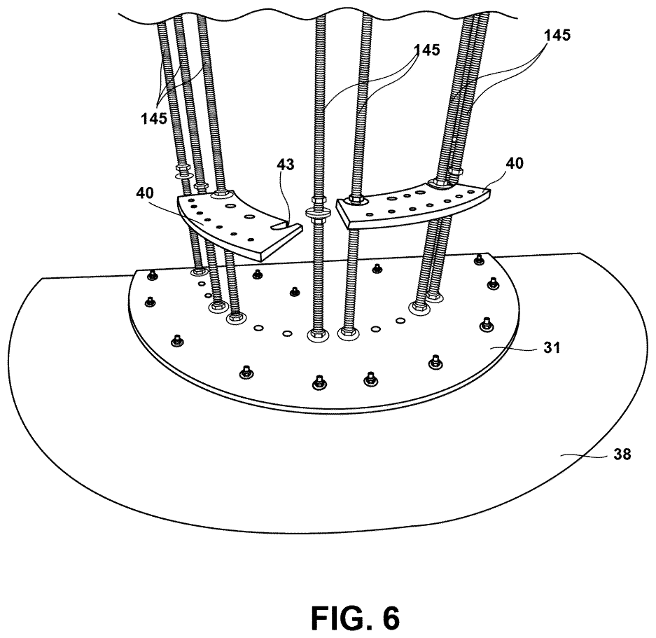

FIG. 6 is another view showing how a wing support bracket having a notch as shown in FIG. 6 may be pivoted to abut the vertical shafts, then secured in place using nuts on washers mounted on the vertical shafts.

Display wings from some manufacturers have a peg that extends downward from the lower back of the display to fit into a hole in the display system, and/or a peg that extends upward from the upper back of the display to fit into a hole in the display system. Display systems from other manufacturers have a displays with holes at the bottom and top of the back that receive pegs extending from the display system. Both configurations allow the display to pivot along its back edge so a consumer may view both sides of a selected display. The present system permits either system to be used. As shown in FIGS. 4 and 6, the wing support brackets are provided with holes sized to receive pegs from display wings that have pegs. If a display wing instead has holes, the equivalent of a peg may be formed in the display support bracket by bolting a short threaded bolt to one of the holes in the in wing support bracket.

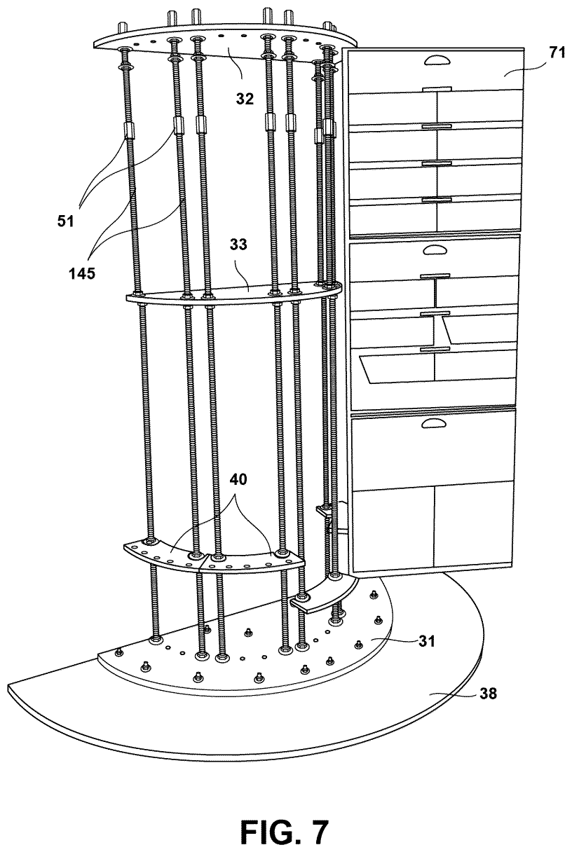

FIG. 7 shows another embodiment of a display system. In this version a display support bracket holds the bottom of a display wing, and the top of the display wing is held by the top support. Other display wing brackets are mounted on the threaded shafts and can be at different heights to accommodate display wings of different heights.

Sample display wings from manufacturers typically include a board, and a structure for mounting the board to the display system. Structures for mounting may include a channel along the back edge of the board that has receives pegs extending from a display, or pegs extending from the top and bottom of the board that fit into holes in a display. Moreover, boards from different manufacturers may be of different widths. The different types and sizes of structures used by different providers of the boards, and the different thicknesses of the boards, complicate the ability to provide a display that can hold boards of any manufacturer. Presently disclosed is a clamp system designed to hold display boards from any manufacturer, including boards of different thicknesses.

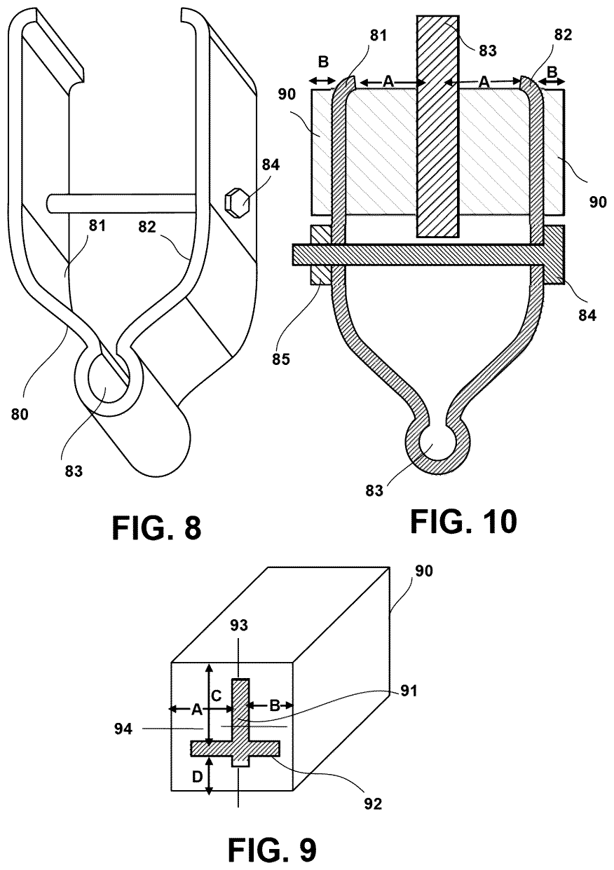

FIG. 8 is a perspective view of a clamp 80 having left and right arms, 81, 82 each of which has a first end and a second end which are joined at channel 83.

This allows the arms to flex toward each other. Clamp 80 also includes a tightening mechanism such as threaded bolt 84 which may be tightened to compress arms 81, 82 toward each other. The clamp system also includes two compressible blocks as shown in FIG. 9. Each block 90, which may be comprised of rubber, has two perpendicular slots, 91 and 92, each of which is sized to accommodate an arm 81, 82 of clamp 80. The slots extend from the front side of the block to the back side. Significantly, the slots may have distances from their parallel sides that are different, in other words, they are offset from the midlines 93, 94 of the block. Thus, by selecting the orientation of the block when placing it over an arm 81 or 82 of clamp 80, it is possible to select the size of the gap between the blocks.

As shown in FIG. 9, vertical slot 91 is slightly offset (to the right) of vertical midline 93, and horizontal slot 92 is offset (below) horizontal midline 94. For example, the distance A between the left side of the block and the vertical slot may be ½ inch, and the distance B between the vertical slot and the right side of the block May ⅜ inch. Similarly, the distance C between the top of block and horizontal slot 92 may be ⅝ inch, and the distance D between horizontal slot 92 and the bottom of the block may be ¼ inch. In one embodiment, the inside distance between clamp arms 81 and 82 may be 1⅜ inch. Thus, by selecting which slot of the block to use and which side will be inside the clamp arms, the gap between the insides of the block may be any where from ⅛ inch to ⅞ inch.

These variations are shown, for example, in FIGS. 10 and 11 which are top cross section views of clamp 80 having a block on each arm 81 and 82. In FIG. 10, blocks are positioned so that a ½ inch portion of each block is between the clamp arms, and a ⅜ inch portion is on the outer side of each clamp arm. This allows the clamp to securely hold a board 83 that is ⅜ inch thick. In FIG. 11, blocks are positioned so that a ⅜ inch portion of each block is between the clamp arms, and a ½ inch portion is on the outer side of each clamp arm. This allows the clamp to securely hold a board 110 that is ⅝ inch thick.

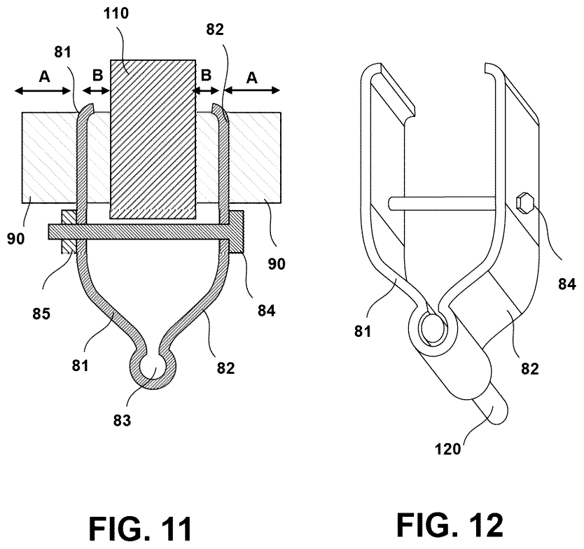

Blocks are preferably comprised slightly compressive material such as rubber or nylon. By tightening bolt 84 after the blocks are mounted on the arms and the board is positioned between them, the display board is securely held by the clamp and may be mounted in the display system. In the clamp version shown in FIGS. 8, 10 and 11, channel 83 may be inserted into a peg extending from the display system to allow the board to pivot about the peg. Alternatively, as shown in FIG. 12, in lieu of channel 83, the clamp may comprise a peg 120 sized to fit into a mating hole in the display system to hold the board.

Another aspect of the present invention is a system that biases the display wings toward a neutral position. A display structure, not necessarily in a curved configuration, holding multiple pivotable wings may be made whereby each wing is positionable in a neutral position in which the wing does not abut or contact any adjacent wing. The structure would further include a means biasing each wing toward its neutral position. This permits easier viewing of a portion of each wing because adjacent wings are not abutting, which allows viewing of each wing. It also reduces the amount of force required to fully open and display a desired wing when all wings are in their neutral position because adjacent wings will not need to be moved as a user begins to move the desired wing to a displayed position.

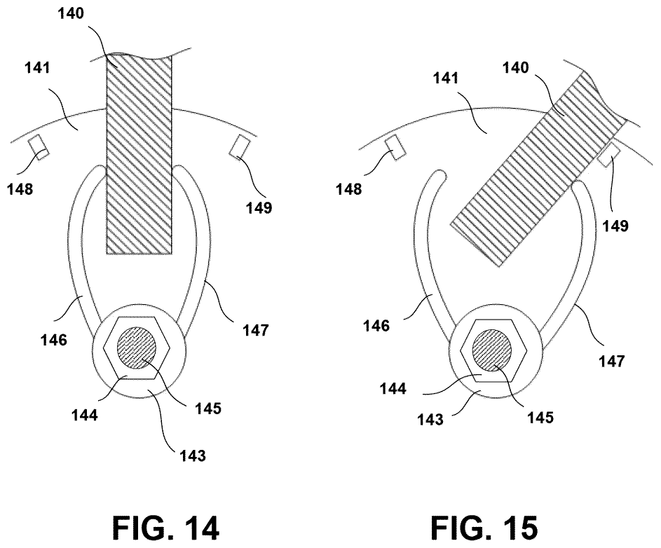

One option for a spring system used to bias each display frame towards a neutral position is shown in FIGS. 14 and 15. FIG. 14 is a partial top cross-section view of the bottom part of a display wing 140 mounted on display wing support bracket or surface 141. Washer 143 and nut 144 hold the bracket or surface at a selected vertical position on threaded shaft 145. As shown in FIG. 14, the washer and nut also hold a spring having two arms 146 and 147 which bias display wing 140 towards a neutral position, such as extending radially outward from the center of the display system. A consumer may pivot a display wing to one side to view it as shown in FIG. 15. In this instance, one of the arms 147 is deflected in the direction of the movement. The position of the display wing can be held in this position by means such as a magnet as described below. When the display wing moved from this open position toward the neutral position shown in FIG. 14, arm 147 of spring will return the display wing 140 to its neutral position.

The display wing support bracket or surface 141 may also be provided with left magnet 148 and right magnet 149, which also act as stops that limit the extent to which the display wing 140 may be pivoted from its neutral position. When display wing 140 is pivoted to the position shown in FIG. 15, right magnet limits the pivoting and also holds the display wing 140 in the pivoted position by magnetic force. When the consumer is finished viewing the display wing, he or she simply slightly pushes it toward the neutral position with enough force to overcome the magnet force, and the spring arms 146 or 147 will return the display wing to the neutral position. Spring arms 146 and 147 may be comprised of any suitable material that is flexible yet maintains consistent shape, such stainless steel.

Another option is using a small detent in the wing support bracket with a small bulb on the wing frame that fits within the detent and is removable with a small amount of force.

When the vertical shafts are positioned in a non-linear or curved configuration, the viewing area of the wings is greater than in the prior art. As shown in FIG. 3, the adjacent wing frames/display boards 35, 36, 37 are able to open to an angle of approximately 150° if so desired. However, it may also be desired to have wing stops that limit the extent to which the wing frames may open. This would be helpful if multiple customers were looking at the same display at the same time in different sections. Therefore, the neighboring wings would not be collapsed on one another making it more difficult to view the desired wing.

FIG. 3 shows a display system including a round base plate 38 and round inner support plate 31. These may be a full or partial oval or circle with the base and support rings being full or cut to allow reconfiguration as desired to full, half, or quarter barrel configurations. The ability to use partial oval or circle base and support rings allows the display system to be positioned around and/or adjacent to a building support column to support the display structure. Connecting the display frame to an existing support column increases the stability and allows the product to have a lighter and smaller base as the column will be able to absorb some of the weight and/or force of the display.

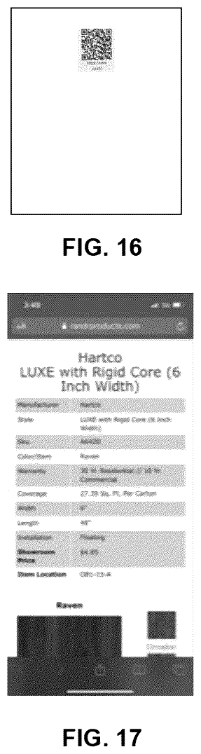

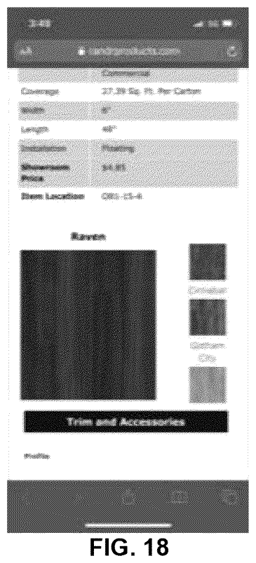

The display boards may also bear a sticker having a QR code, barrel (display) identifiers, wing identifiers, and sample identifiers as shown in FIG. 16. When a customer scans the QR code using a QR code reader, like a smartphone, the hardware will connect with the software and provide related information to the customer as shown in FIGS. 17 and 18. That information can include price, availability status, backorder status, discontinued status, and similar products amongst any other information programmed into the database that communicates with the software. A customer may also receive a quote or place an order through a webpage or app displayed in response scanning the QR code.

The QR system may also include a database having identifiers for multiple store locations. One embodiment of the system further includes a means for receiving geolocation information from the hardware used to input quoting or ordering information and a means for quoting pricing information based on the received geolocation information. Once a QR code is scanned, the seller or dealer may also receive information about the customer, such as which codes they have scanned and therefore which types of flooring they may be interested in.

Other options for allowing the wing frame to be held open at a stopping point include a small detent in the wing support bracket with a corresponding notch on the wing frame, similarly corresponding Velcro pieces, or any other suitable means that would allow for stopping and releasing the wing frame with minimal force.

It is desirable for a customer to be able to view both sides of the product display wings with minimal effort without removing the sample from the display, and for the display system to hold product samples of various sizes, weights and types. Typical product display wings may be 2.5 ft. wide or smaller, a height of 6 ft. and be from ¼″ to 2″ thick. The types of products that may displayed on a display wing include carpet, hardwood, laminates, ceramic, vinyl, many other flooring products, roof shingles, windows and window treatments and other products. Many of these products can be displayed at the same time on the same display.

The display system may be freestanding, so it does not require connection to a wall, support column or other structure.

Product display wings can be adjusted vertically to any desired height by adjusting the location of product wing support brackets on threaded shafts. Because threaded shafts are used, any desired vertical location may be achieved, as threaded nuts on the shafts can be rotated to any desired height. This allows different display wings to be easily swapped into or out of the system as product needs change, without the need to purchase different displays.

In one embodiment, the display system can have a quarter-circle footprint, which can be especially ideal for an interior corner in a showroom. The quarter circle footprint also allows two systems to be placed in abutting relationship to create a semi-circular display, or four systems may be used to create a circular display. These space-conserving designs can reduce the floor space needed for product displays by 30 percent or more.

The optional use of an upper bracket also allows optional lights to be installed to provide additional light for the products on the display wings.

In one embodiment, a full circular display may have a structural load capacity of approximately 2,500 lbs. Leveling features may be built into the baseplate or legs of the display to accommodate uneven floors. Pads may be mounted to the base support structure to protect showroom flooring. In one embodiment, a bolt extends from an hole in the top of the leg. Threaded onto it in an intermediate position is a locking nut with a nylon insert. The bottom of the bolt is attached to a rectangular levelling plate that is slightly smaller on each side than the width of the leg and is surrounded by the leg. The bottom of the levelling plate may be glued to carpeting so it does not mar the floor of the showroom. The bolt may be rotated to move the levelling plate and the leg to which it is attached up or down as needed to accommodate variances in floor height.

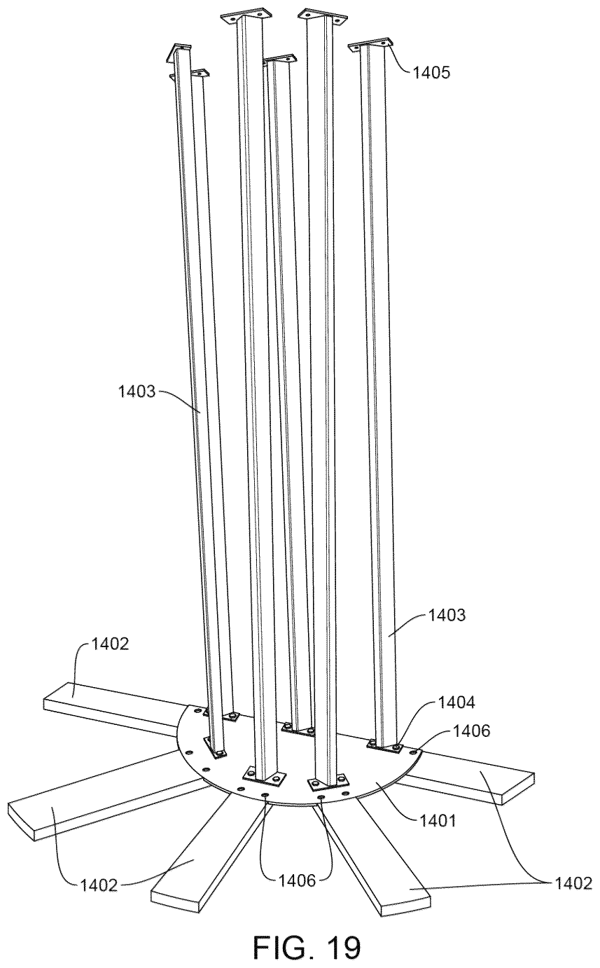

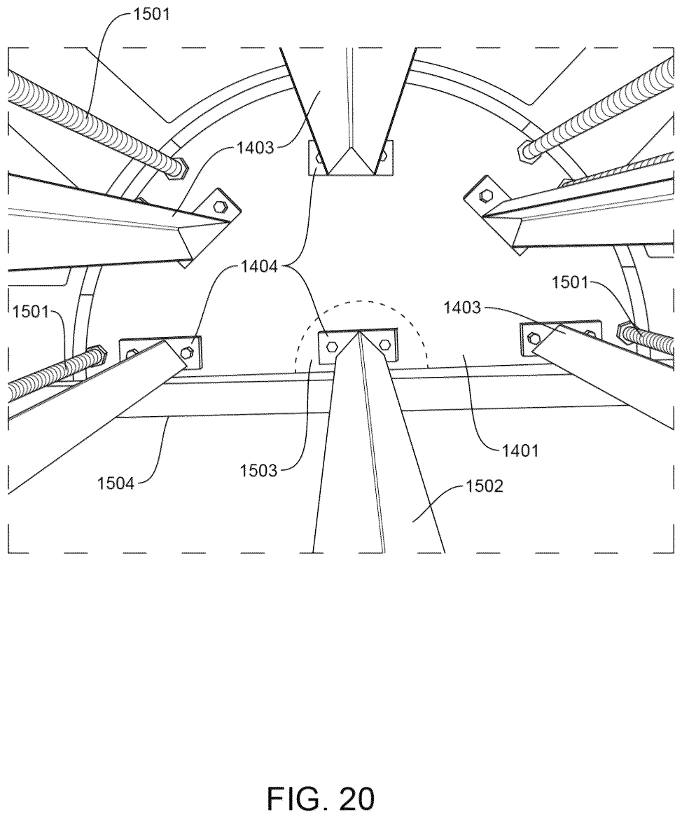

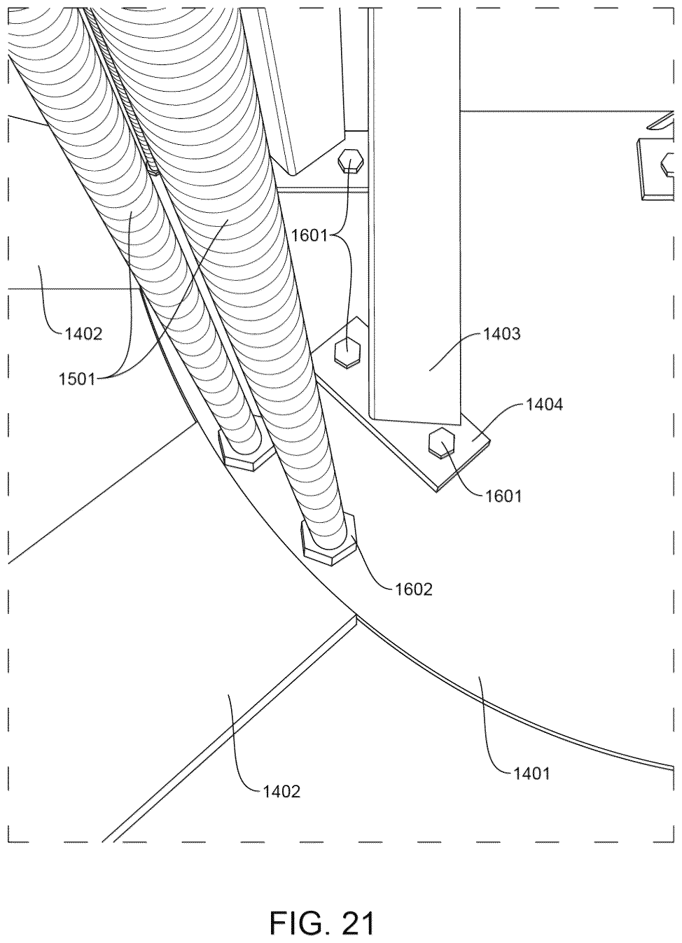

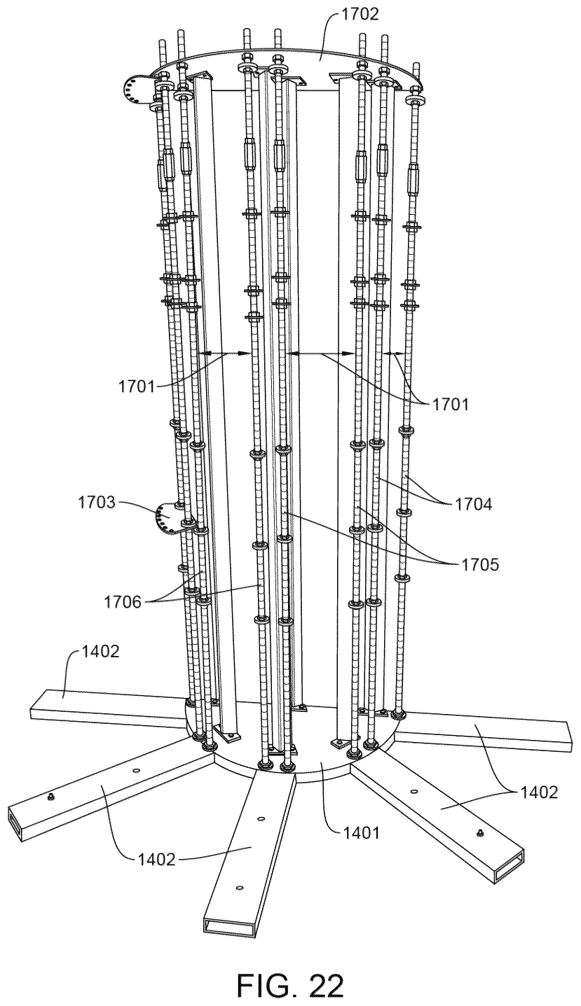

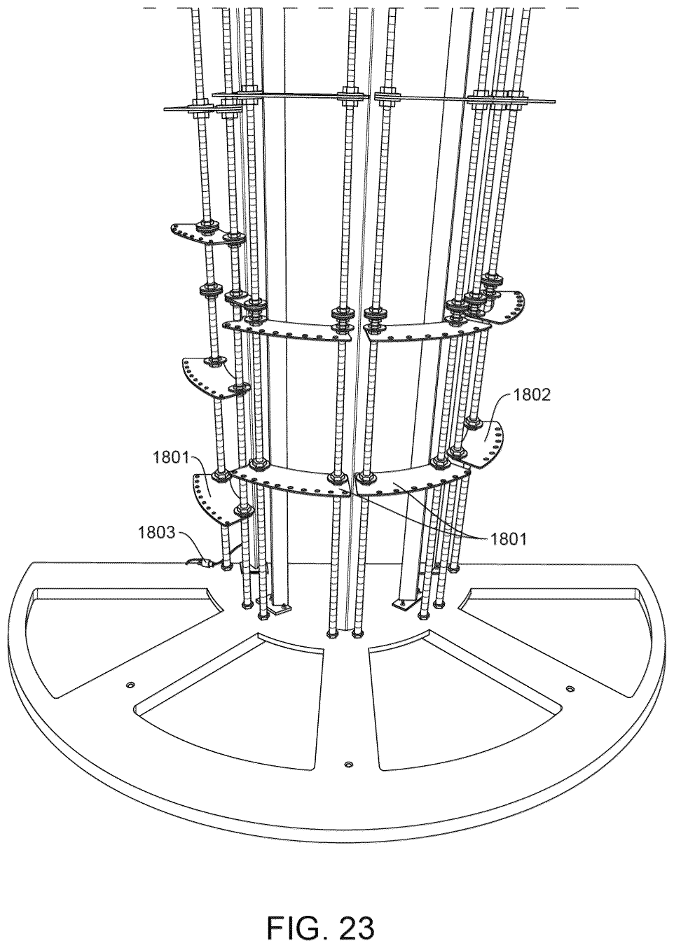

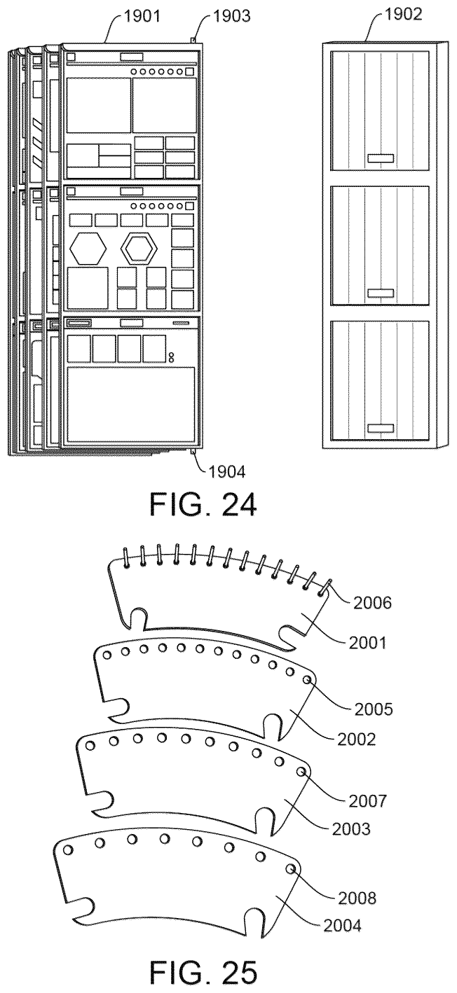

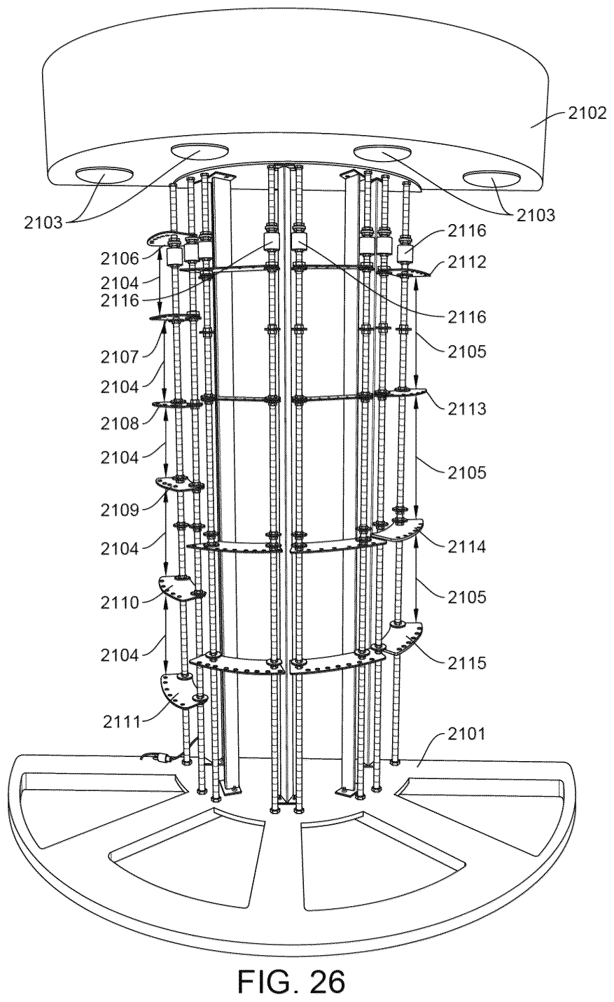

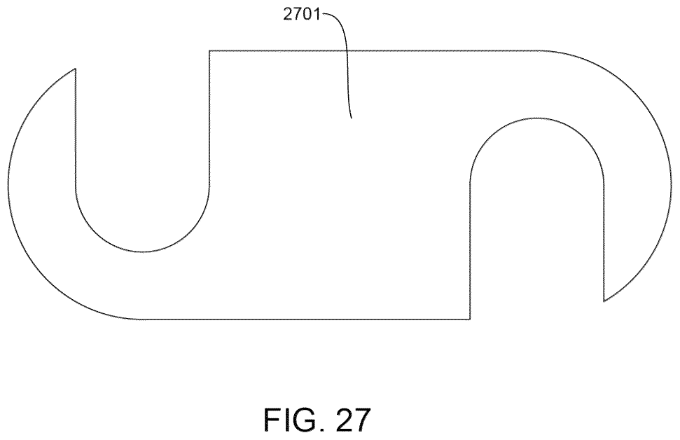

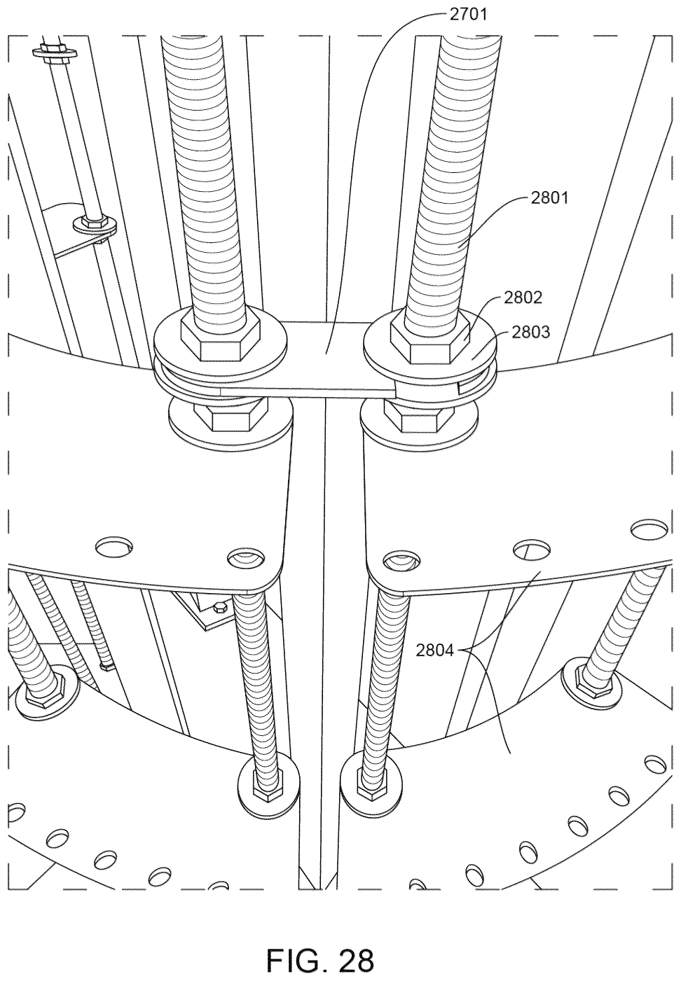

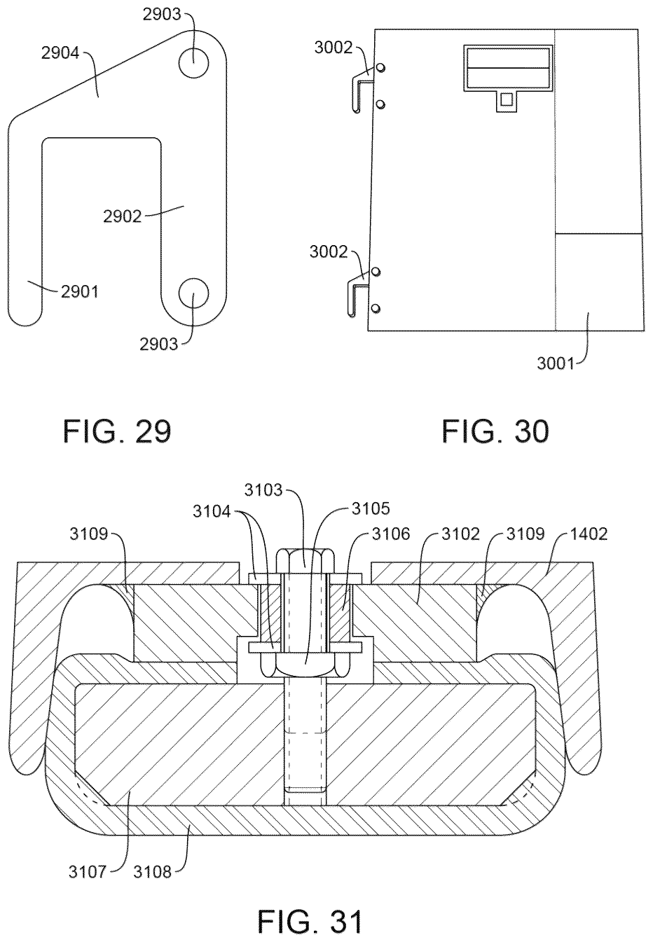

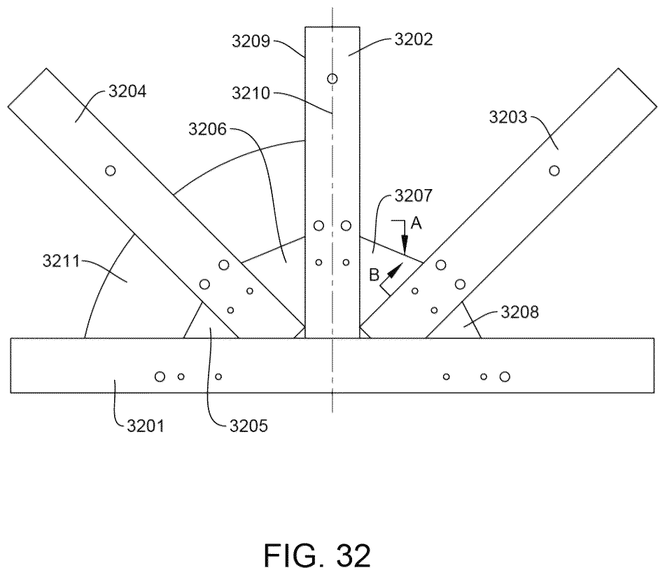

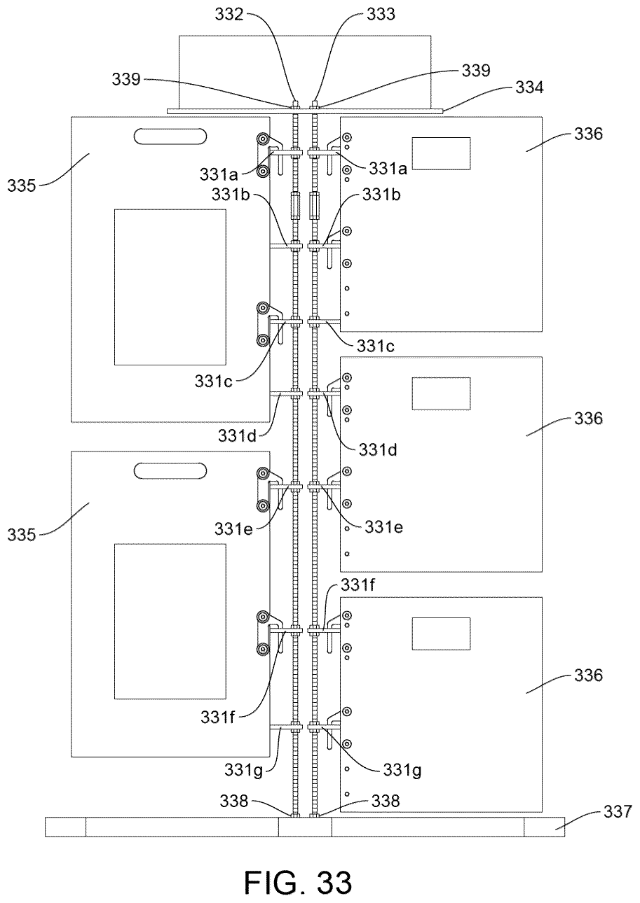

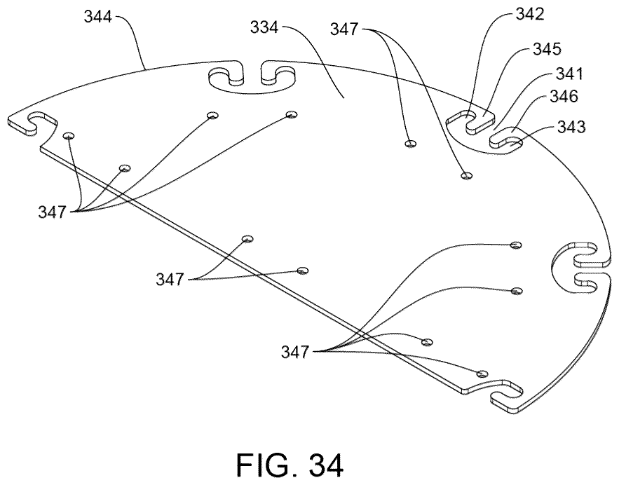

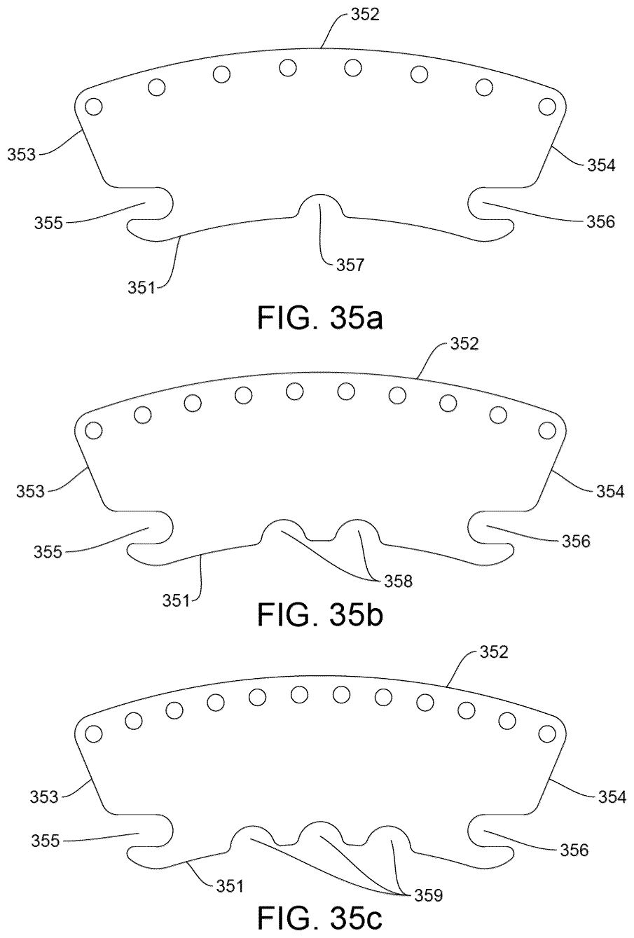

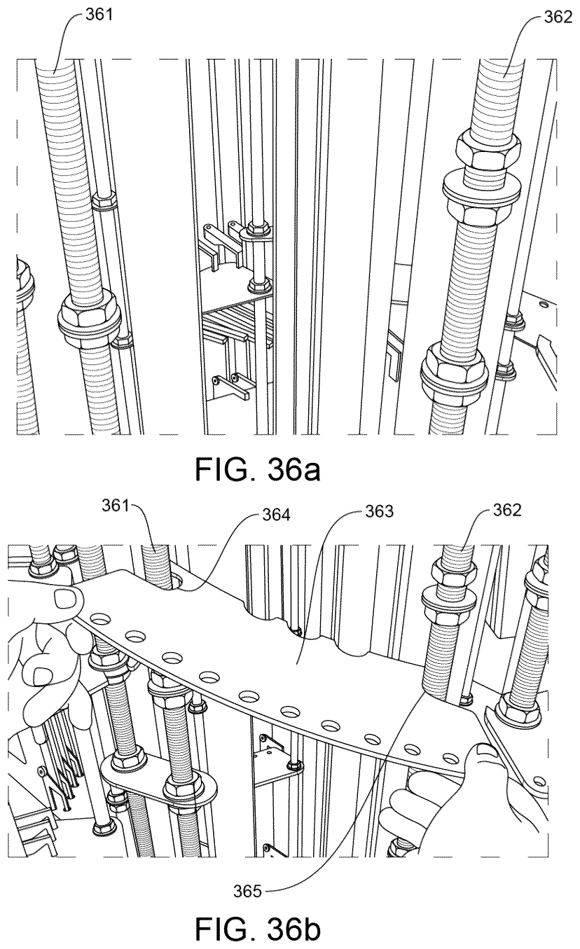

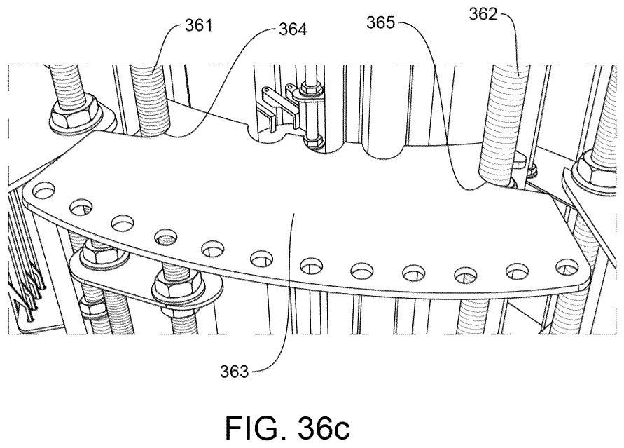

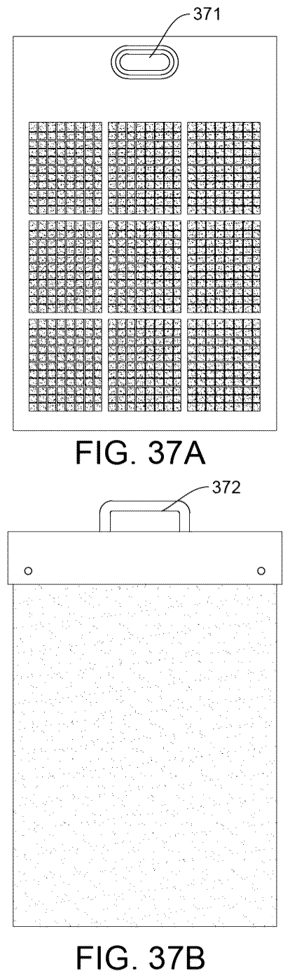

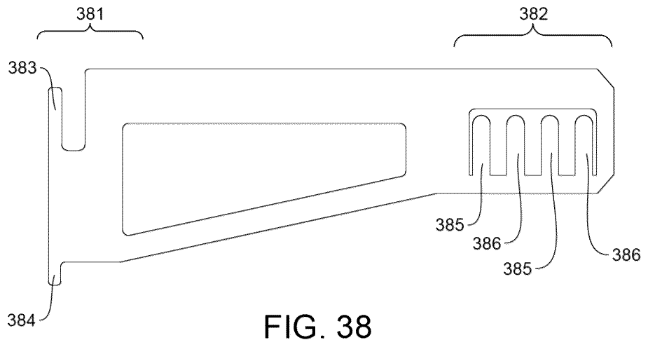

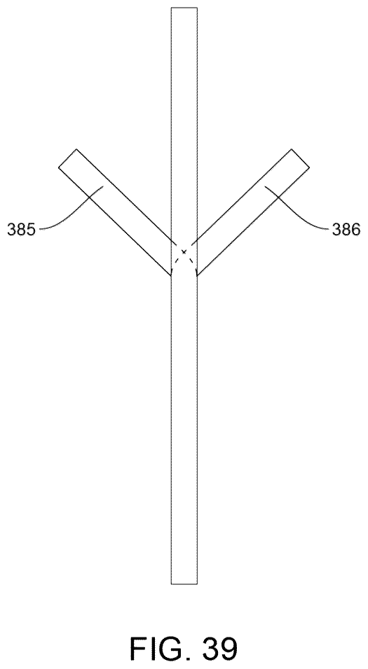

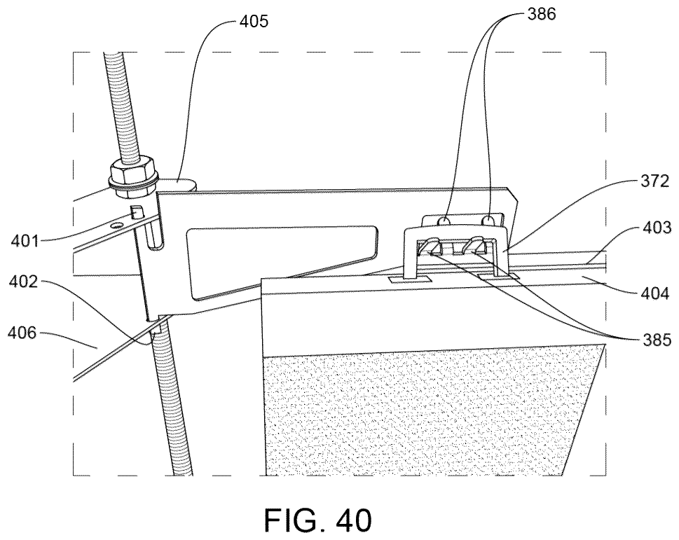

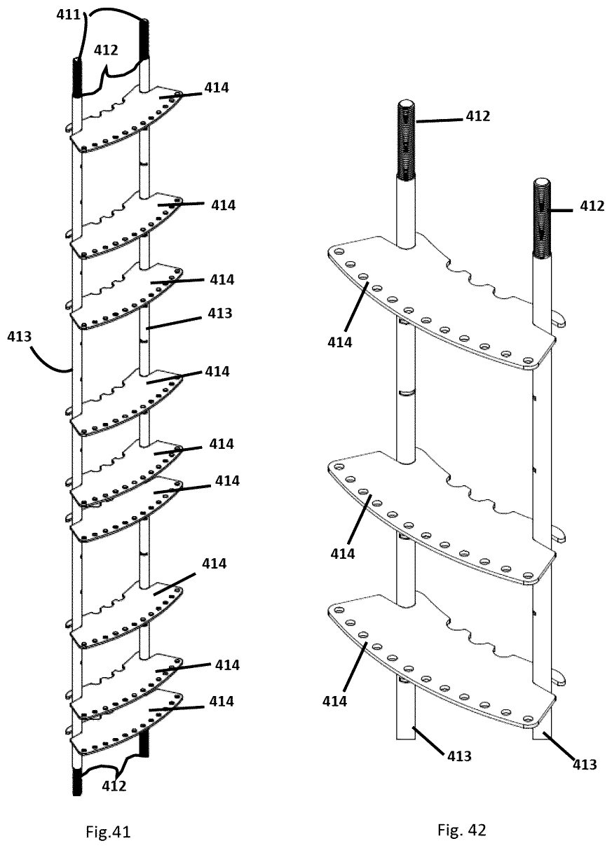

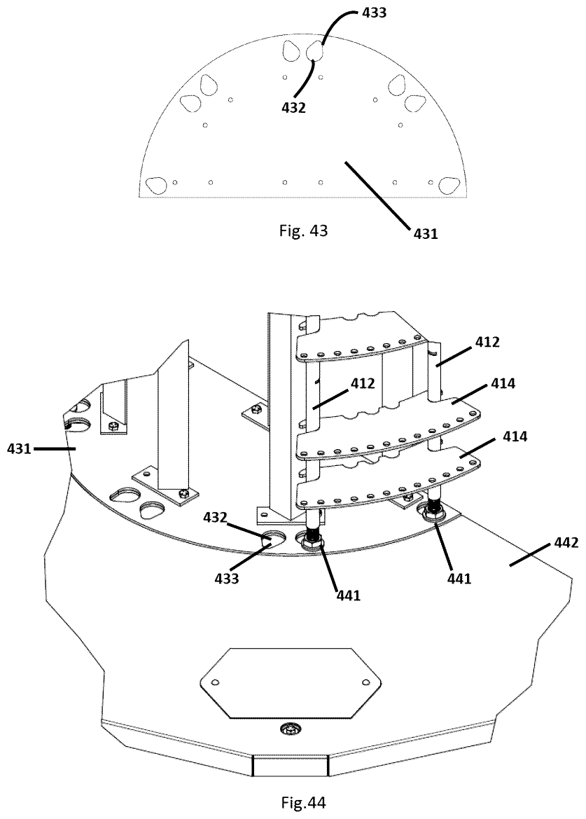

FIG. 19 is an exemplar of components of a display system including rigid support structures. Semi-circular steel baseplate 1401 includes legs 1402 which impart stability to the display system and prevent tipping when the display is loaded with display wings as shown in FIG. 3. A plurality of rigid support structures 1403 may be comprised of steel angles and are attached to baseplate 1401 and 1402, such as by being welded to rectangular plate assemblies 1406 which in turn are bolted to baseplate 1401, or otherwise connected as described herein. Baseplate also includes holes 1406 to receive threaded rods.

FIG. 20 is a downward looking view from the middle of system showing the locations of a center area 1503 in baseplate 1401, rigid support structures 1403, and threaded shafts 1501. In one embodiment, rectangular plate assemblies 1404 may be welded to the ends of rigid support structures 1502 where manufactured. At the showroom where the display system is installed, the rigid support structures with the baseplate assemblies may be bolted to baseplate 1401 and 1504. Baseplate 1401 may include a straight edge 1504. This configuration allows two display assemblies to be placed in a back to back abutting relationship to form a circular or elliptical display system. It will also be appreciated that a display system may be configured with a quarter-circle baseplate. This will allow the one system to be positioned in the interior corner of a room, or two to be placed in an abutting position to form a semicircle, or three to be placed in an abutting position and placed in a ¾ circle relationship surrounding a wall intersection, or four may be placed in an abutting position to form a circular display. Threaded shafts 1501 are attached to baseplate 1401 and 1504 by nuts both below and above the baseplate. The use of steel angles for the rigid support structures provides a display that is sufficient to stably hold a fully loaded product display, while light enough to be both shipped and moved within a showroom. The orientation of the steel angles so their central portions face the curved perimeter of the baseplate further improves the stability of the system.

FIG. 21 shows floor baseplate 1401 legs 1402, rigid support structures 1403, and threaded shafts 1501. It will be appreciated that the rigid support structures 1403 and threaded shafts 1501 may be positioned over the legs, which provides improved transfer of the load carried by these components. Plates 1404 may be welded to the rigid support structures 1403, and bolted to baseplate 1401 and 1402.

FIG. 22 is a view of a display system including rigid support structures, and also showing the floor baseplate 1401 with legs 1402 with levelling mechanisms (represented by the threaded bolts in the distal part of legs. By rotating the bolts, a particular leg may be adjusted to compensate for irregularities in the height of the floor where the display system is installed. In this embodiment, each pair 1704, 1705 and 1706 of threaded shafts has one shaft located over one leg, and the other shaft located over another leg. This configuration helps distribute the load of the product display wings among the legs to stabilize the display. The distances 1701 between threaded shaft pairs 1704, 1705 and 1706 is the same. This allows a wing support bracket 1703 to be placed between any threaded shaft pair. This gives the merchant flexibility in deciding which products to display at which locations on the display system. The uppor part of threaded shafts are attached to upper plate 1702.

FIG. 23 shows how different wing support brackets 1801, 1802 may be secured on threaded shafts at selected heights, to thereby accommodate display wings of differing heights. Normally, a first wing support bracket will be mounted on a pair of threaded shafts below the product display wing it holds, and a second wing support bracket is mounted on the same pair of threaded shafts.

FIG. 24 shows two versions of product display wings. Product display wing 1901 us upper peg 1903 and lower peg 1904, and pivots about an axis intermediate those pegs. The pegs fit into holes of wing support brackets as shown in FIG. 25. Product display wing 1902 has an exterior frame with holes (not shown) in the upper and lower corner in about the same position as the pegs of wing 1901. To mount product display wing 1902, the wing may be lifted so the hole in the top corner surrounds a downwardly projecting peg from an upper wing support bracket, and then the wing is tilted until the hole in the bottom corner is over an upwardly projecting peg 2006 of a lower wing support bracket. The wing is then dropped so its weight is held by the lower wing support bracket.

FIG. 25 shows versions of wing support brackets having pegs and holes for holding product display wings, 2001, 2002, 2003 and 2004. In one embodiment, a product display wing comprises an inner edge, and outer edge, a first side edge and a second side edge, a top surface and a bottom surface. The inner edge may be concave, and the outer edge may be convex. The upper surface may comprise a plurality of display wing connection means proximate the outer edge, each such connection means adapted to hold a product display wing such that the product display wing may pivot along a vertical axis extending perpendicularly from the connection means. The connection means may comprise pegs 2006, holes 2008, or any other structure that permits a product display to pivot. The connection means may include bushings, bearings or washers or other components to reduce friction. The inner edge may have a notch extending between the top and bottom surfaces and sized to receive a first vertical threaded shaft to hold the wing support bracket to a vertical threaded shaft. In 2001, the notch in the inner edge is on the left, and in 2002-2004, the notch is on the right. The first side edge may also have a notch extending between the top and bottom surfaces and sized to receive a vertical threaded shaft to hold the wing support bracket to a second vertical threaded shaft. In 2001, the notch of the first side edge is on the right, and in 2002-2004, the notch is on the left. In this embodiment, the notch of the side edge may be inserted around a threaded shaft, and the wing support bracket may be pivoted until the notch on the inner edge engages another threaded shaft. Nuts on the threaded shaft may be tightened above and below each notch to hold the wing support bracket at a selected height on the threaded shaft, as shown in FIG. 26. By use of these notches, a wing support bracket can be added, removed or relocated on the display system after it is assembled, i.e., after the threaded shafts have been secured to bottom and upper plates. This makes the system easier to use as compared to a wing support bracket that has only holes through which the threaded shafts must be inserted during assembly of the display system.

The number of connection means on a wing support bracket may vary to accommodate product display wings of different widths, as the wings are often supplied by a product manufacturer. For example, wing support bracket 2001 has 13 pegs, and may accommodate 13¼″ wide product display wings. Wing support bracket 2002, 2003 and 2004 have 12, 10 and 8 holes, respectively, so they can accommodate product display wings of increasing thickness. Typically, two wing support brackets will be required for set of product display wings held, one at the top and one at the bottom. Thus, for a configuration where four sets of product display wings will vertically held by two threaded shafts, eight wing support brackets are typically required; one at the top and one at the bottom of each set of display wings. This would require sixteen nut-washer sets on each threaded shaft so there can be a nut-washer set both above and below each wing support bracket. In addition connectors 51 (FIG. 5) or 2116 of FIG. 26 may be used to form continuous threaded shafts of a desired height. For example, the use of connectors 51 or 2116 allow a standard length 6 foot threaded shaft to be used at the bottom and a 1 foot or 18 inch threaded shaft immediately above. The use of these standard length threaded shafts reduces manufacturing cost. In addition connector 2116 can be disconnected from the upper and lower threaded shafts which will allow removal or addition of nuts and washers to add wing support brackets without complete disassembly of the entire display.

FIG. 26 shows a display system in which the upper plate holds lights 2103 that project downward toward the area where product display wings may be positioned, and a removable arcuate display 2102 extending from the upper plate. Arcuate display may be a flexible material and printed with descriptions of the products displayed, names of manufacturers, information about sales, or any other information a merchant may desire.

FIG. 26 also shows wing support brackets being positioned at differing heights so they may hold product display wings of different heights. The left-most set of wing support brackets 2106, 2107, 2108, 2109, 2110, and 2111 may be spaced to hold product display wings of a first height 2104, while the right-most display support brackets 2112, 2113, 2114 and 2115 may be spaced further apart by distance 2105 to accommodate taller product display wings. Each wing support bracket is held in place by two sets of upper and lower washers and nuts.

The number of nuts required for a threaded shaft may not be known when a display system is assembled. For maximum flexibility, it is desirable to thread enough nut-washer combinations onto each threaded shaft that would ever be needed. If taller product display wings are used which require fewer wing support brackets, the extra nut-washer combination can be remain unused. However, they will be available if the merchant decided to modify the display to use more vertically stacked display wings, without having to disassemble the display system.

FIG. 27 shows an S connector 2701 suitable for securing adjacent threaded shafts to increase the structural integrity of the display system. The two notches in the S connector may be the same size as the notches in the product display wings shown in FIG. 25. It may be used between adjacent threaded shafts in lieu of, for example, the central support shown as 33 in FIG. 5. Because it is smaller, it facilitates a display that is lighter, easier to use and less expensive.

FIG. 28 shows an S connector 2701 mounted to adjacent threaded shafts. Sets of nuts 2802 and washers, 2903 are tightened above and below S connector 2701. While display wing brackets 2804 provide horizontal stability for the threaded shaft pairs on which they are mounted, S connectors 2701 provide additional horizontal stability between sets of pairs of threaded shafts.

FIG. 29 shows a bracket which may be attached to product samples to create product display wings. Bracket may have an attachment member 2902 having holes 2903 which may be used to screw or rivet bracket to a product sample as shown in FIG. 30. Lateral extension 2904 extends from attachment member and peg 2902 extends form lateral extension 2904. Peg 2901 may be inserted into a hole 2005, 2007 or 2008 of a wing support bracket 2002-2004 as shown in FIG. 25.

FIG. 30 shows a product display wing made by a product sample with two brackets of FIG. 29 attached thereto. Product sample 3001 is typically supplied by a product manufacturer, and may comprise a sample of flooring, carpet, tile, shingles or other material to be displayed. If product sample 3001 is not a rigid material, it may be affixed to a backboard so it does not flex. Brackets 3002 may be attached to product sample 3001 to thereby form a product display wing. The distance between brackets 3002 may be selected to match the distance between wing support brackets, such as distance 2104 or 2105 as shown in FIG. 26. A product display wing with the brackets as shown allows the display wing to pivot around the peg 2901. Also, the display wing may be easily lifted to remove it from the display so a customer may view it more closely. In addition, if a retailer wishes to replace a product display wing, the bracket may be recycled by removing from one product display and mounting them on a different product display.

FIG. 31 is a cross section of a system for leveling a display system on uneven flooring and also a feature to protect the display showroom floor when needing to move the display to another area. The system consists of a rectangular steel housing 3102, a steel spacer 3106 is inserted into the steel housing and is free to rotate with respect to the 3102 housing. Steel housing 3102 may be welded to the interior of channel at welds 3109. Bolt 3103 is inserted into the 3106 spacer with a 3104 washer, one each end of the 3106 insert as shown in FIG. 31. A nut 3105 is threaded onto the bolt 3103 and torqued to 38 foot lbs. By design the length of the spacer 3106 is greater than the length of the counter bore in housing 3102 to allow vertical movement of the washers 3014. The washers 3014 will move in a circular movement. The leveling block 3107 has a threaded hole in the center and is wrapped with a protective material such as commercial carpet tile 3108.

These components may be assembled into a 5″ channel or leg 1402 by threading bolt 3103 into the leveling block 3107. Bolt 3103 is turned in clockwise direction to position the leveling block as shown in the installed position in FIG. 31. Upper washer 3104 provides a ground for the vertical movement and the sides of the 5″ channel 1402 provides the circular ground for leveling block 3107. When leveling is needed bolt 3103 is turned in a counter-clockwise direction and lower washer 3104 provides the ground for the procedure.

FIG. 32 is a bottom view of legs of a product display system. For a half circle display system, back leg 3201 may be provided, with a central perpendicular let 3202 and 45 degree legs 3203 and 3204. The legs may be comprised of channel steel as shown as 1402 in FIG. 31. To improve structural integrity, steel gusset plates 3205, 3206, 3207 and 3208 may be welded to the legs where they abut. For a quarter circle display system the perpendicular leg may be half width, i.e., only from side 3209 to midline 3210. This will allow two quarter circle display systems to be placed so they abut each other to form a half circle display. A quarter circle display may also abut a half circle display to create a ¾ circle display, or four may be combined to form a full circular display. In any of these configurations, a baseplate cover 3211 may be added and bolted to the legs to provide additional structural integrity or a more pleasing appearance when viewed from the top.

FIG. 33 shows a display system having support brackets (paddles) 331a-331g at seven different heights, which is able to accommodate a wide variety of samples of different sizes positioned at various vertical heights. Each wing support bracket is rigidly to a plurality of supports, such as threaded shafts 332, 333 to hold the wing support bracket at a fixed distance from the upper structure or top plate 334, which may be 55 inches from floor baseplate 337. In one embodiment, a first wing support bracket 331a is 0.5″ to 3.5″ below the top plate 334, a second wing support bracket 331b is 11.5″ to 14.5″ below the first wing support bracket, a third wing support bracket 331c is 6¾″ to 9¾″ below the second wing support bracket, a fourth wing support 331d bracket is 6¾″ to 9¾″ below the third wing support bracket, a fifth wing support bracket 331e is 9¼″ to 12¼″ below the fourth wing support bracket, a sixth wing support bracket 331f is 16¾″ to 19¾″ below the fifth wing support bracket, and a seventh wing support bracket 331g is 8¾″ to 11¾″ below the sixth wing support bracket. The distances/ranges provide an optimal number bracket heights so that a wide variety of product samples of different heights may be accommodated. For example, first product sample 335 has a first height, and second product sample 336 has a different height, and all are located above floor base plate 337. Each product sample may be held to wing support brackets by hooks as shown in FIGS. 29 and 30.

In one embodiment, two hooks a fastened to product samples as shown in FIG. 30. Hook 3002 at the top of the sample may be positioned so that the portion that engages a sample support bracket is about 3 inches from the top of the sample. For product samples 24 inches or less in height, the hook at the bottom of the display may be positioned so that the portion that engages a lower sample support bracket is about 12¾ inches from the top of the sample. For product samples greater than 24 inches in height, the hook at the bottom of the display may be positioned on the sample so that the portion that engages a lower sample support bracket is about 20¾ inches from the top of the sample. When used with support brackets having the optimal distances between them described above, these between the top of the sample and the two hooks provide a near optimum configuration, as samples of virtually any height may be displayed on the display system. There is always a suitable combination of support brackets that will accommodate a product sample of virtually any height.

FIG. 34 is view of a top plate or top structure of a display system having multiple channels with right and left arms, which allow the tops of threaded shafts (such as 332 and 333) to be temporarily removed from the top plate so washers and nuts may be added or removed to the shaft while minimizing disassembly and reassembly of other display components. As a display system is assembled, threaded shafts 332 and 333 may be loosely positioned in floor baseplate 337. Top plate 334 has outer edge 344. The tops of threaded shafts may each be inserted into channel 341, then moved into left arm 342 and right arm 343, which form left flange 345 and right flange 346. Other threaded shafts may similarly be inserted into the other channels and arms of top plate 334. The threaded shafts may be rigidly secured to top plate 334 by nuts and washers above and below the plate. It may be desirable to add or remove nuts and washers to threaded shaft 332 and 333 when it is desired to adjust the number of wing support brackets to be mounted. Instead of completely disassembling the display system, the bottom nuts 338 securing shafts 332 and 333 to bottom plate 337 may be loosened. Then nuts 339 holding the shafts 332, 333 to top plate 334 may be loosened enough to allow the shafts to be moved through arms 342, 343, and out of channel 341 to the outside the outer edge 344. Then nuts and washers may be threaded onto or removed from threaded shafts 332, 333 to the desired heights. Then threaded shafts may be reinserted into channel 341 and arms 342, 343 and the nuts holding them tightened. Top plate 334 may also include apertures 347 for securing rigid support structures 1403 as shown in FIG. 19.

FIGS. 35a-35c show wing support brackets having notches in opposing side edges, eight, ten and twelve support holes or pegs, respectively, and identification cut-outs that reflect the number of holes or pegs. When assembling a display system, the widths of product samples may vary, which impacts the number of samples that may be mounted on a wing support bracket. The brackets in FIGS. 35a, 35b and 35c have 8, 10 and 12 product sample connection means, respectively. The means may comprise either apertures, or pins/pegs as shown in FIG. 25, and it may be desirable to position different types of support brackets at different locations on the display system. A representative circular display system may have eight brackets at each level and eight levels (heights), for a total of 64 of brackets. When assembling a display system, because support brackets have similar shapes, even when they have different numbers of sample connection means (as shown in FIG. 25 or 35a-35c), it can be difficult to ensure that the support bracket installed at a particular location has the correct number of product sample connection means. Therefore notches may be formed in the inner or outer edge of support brackets, and the number of notches may correspond to the number of the sample connection means of the bracket. For example, the bracket of FIG. 35a has one notch 357 and 8 sample connection means, FIG. 35b shows two notches 358 and 10 sample connection means, and FIG. 35c shows three notches 359 and 12 sample connection means.

FIGS. 36a-36c show how a paddle or support bracket of FIGS. 35a-35c may be secured to two threaded rods. As discussed above, the display system allows the number and location of support brackets to be changed. Each of the support brackets in FIGS. 35a-35c has a left notch 355 in first side edge 353 and a right notch 356 in second side edge. These notches are located between inner edges 351 and outer edges 352. When installed, the bracket cannot shift inward or outward as it is held in place by the shafts that fit in notches 355 and 356. This contrasts with the brackets shown in FIG. 25, in which at least one of the notches is on the inward facing side, so there is potential for it to slip inward or outward after installation. Brackets can be easily inserted or removed from the display system. For example, FIG. 36a shows two threaded shafts 361 and 362 that can hold a support bracket. To insert a support bracket (or paddle) in the system, as shown in FIG. 36b, the bracket 363 is tilted so the left side is higher than the right side and the positioned so shafts 361 and 362 fit into notches 364 and 365. As shown in FIG. 36c, the left side is then lowered until it is horizontal and rests on nuts/washers threaded onto shafts 351, 362, as shown for brackets 331a-331g in FIG. 33. Nuts above and below the brackets can then be tightened to hold them in place.

FIGS. 37a and 37b show sample deck boards having handles 371 and 372 respectively for hanging the deck board. These deck boards can be held by the deck board bracket shown in FIGS. 38, 39 and 40.

FIG. 38 is a side view of deck board holder that can be held by support brackets. Holder has inner end 381 and outer end 382. Inner end 381 is configured to removably hold to a deck board holder connection means 383, 384. These may be pins that fit into apertures in support brackets as shown as 2005, 2007 or 2008 of FIG. 25 or 401 FIG. 40, or a recess that accommodates pins or pegs as shown as 2006 of FIG. 25, or a combination of both. Ideally the deck board holder connection means may pivot with respect to the support brackets holding it.

FIG. 39 is an end view of the deck board holder shown in FIG. 38, which shows that alternate tabs 385, 386 are bent to the left and right, respectively.

FIG. 40 shows the deck board holder mounted in a support bracket, in which the tabs 385, 386 on the alternate sides each hold deck boards 403, 404. In this view, deck board holder includes pegs or pins 401, 402 that fit into deck board holder connection means, namely apertures of support brackets 405, 406, and pivot about them along a vertical axis extending perpendicularly from the apertures.

In one embodiment, the display system may be comprised of multiple columns of product sample support brackets, in which with each bracket is welded or otherwise permanently affixed to two shafts. In such an embodiment, a column of sample support brackets fixed at desired heights to accommodate a particular size of product displays. For example, if Manufacturer A supplies product samples that are 24 inches high, then two sets of samples may be display in vertical orientation, for example as shown in the left side of FIG. 33. Manufacturer B may supply product samples that are 18 inches high, which allow three sets of samples to be displayed in vertical orientation, as shown in the right side of FIG. 33. If a retailer wishes to switch from displaying samples from Manufacturer A to Manufacturer B, the retailer either use a display in which the shafts are entirely threaded from top to bottom as shown in FIG. 33, and adjust the heights as desired. However, long threaded shafts can be expensive. An alternative is to use a tubular shaft that has short threaded shafts at the top and/or bottom as shown in FIG. 41, and in which the sample support brackets are welded to the shafts at heights to accommodate samples from a particular manufacturer. This way, a retailer may first use a first column of display brackets in which the heights of the support brackets are positioned for samples from Manufacturer A. If desired, the retailer may replace the first column with a second column in which the heights of the support brackets are positioned for samples from Manufacturer B. This can save time and money in two ways. First, it likely takes less time to remove and insert an entire column of support brackets than it does to loosen the nuts of specific support brackets and adjust their vertical height. A second advantage may result from the fact that threaded shafts are often more expensive that a non-threaded shaft or tube. Thus, it can be more economical to provide two different columns in which the shafts are comprised of relatively inexpensive metal tubing, and in which the sample support brackets are welded to the tubes at the desired height for the particular manufacturer. Thus, a “Manufacturer A” column may be quickly swapped out for a “Manufacturer B” column, which will allow the retailer to always display samples from its desired manufacturers.

FIG. 41 a column of wing support brackets (paddles) in which each bracket is permanently or semi-permanently affixed to two shafts. Shafts 411 may comprise metal tubes 413 having threaded shafts 412 welded into the ends of the tubes. Sample display brackets 414 may be of the same shape described in FIGS. 35a-36c, but in this embodiment they are welded to the tubes and desired heights.

FIG. 42 shows the top of a column of wing support brackets (paddles) mounted on a shaft having threads at the top of the shaft. The lower part of the shaft may be tubular 413, and it may have threads 412 extending from the top of the tube which are welded to the shaft. Threads 412 may receive nuts to secure the shaft to the top and/or bottom plate.

FIG. 43 shows a plate 431 having teardrop-shaped holes to receive the tops and/or bottoms of shafts. A plate of the shown design may be utilized in lieu of the plate shown in FIG. 34. Plate 431 has multiple pairs of tear-drop-shaped holes. Each teardrop-shaped hole comprises a wide end 432 and a narrow end 433. Wide end 432 is sized to permit the nut 441 on one of the first threaded ends to pass through the wide end 432, and the narrow end 433 is sized to prevent the nut from passing through the narrow end.

FIG. 44 shows the bottom of a display having a bottom plate of FIG. 43 with a column of wing support brackets as shown in FIG. 41 secured to the teardrop-shaped holes. To secure column to the bottom plate, two nuts may be threaded on the threads at the bottom of each shaft 412. The column is then lowed into the inner, wide end 432 of holes, until the bottom nut is beneath plate 442 but the top nut 441 is above the plate. Then the column is pulled toward the edge until the shafts 412 abut the narrow ends 433 of plate 431. Nuts 441 can then be tightened to secure the column to the bottom plate. A same plate 431 may be used as the top plate, and the column may be similarly secured to the top plate.

While the invention has been illustrated and described in detail in the foregoing drawings and description, the same is to be considered as illustrative and not restrictive in character, it being understood that only illustrative embodiments thereof have been shown and described and that all changes and modifications that are within the scope of the following claims are desired to be protected.

All references cited in this specification are incorporated herein by reference to the extent that they supplement, explain, provide a background for or teach methodology or techniques employed herein.

What is claimed is:

1-66. (canceled)

67. A display system for holding multiple product samples wherein a first product sample is held above at least one second product sample by the display system, comprising:
a floor baseplate,
an upper structure,
a plurality of supports, each support comprising an upper end and a lower end, each lower end being rigidly connected to the floor baseplate and each upper end being connected to the upper structure, whereby the floor base and upper structure are separated by at least 55 inches,
at least first, second, third, fourth, fifth, sixth and seventh wing support brackets, each wing support comprising:
an inner edge,
and outer edge,
a plurality of attachment members along the outer edge, each attachment member permitting a product sample to be pivotably held,
each wing support bracket being rigidly affixed to the plurality of supports to hold the wing support bracket at a fixed distance from the upper structure, and wherein:
the first wing support bracket is 0.5″ to 3.5″ below the top plate,
the second wing support bracket is 11.5″ to 14.5″ below the first wing support bracket,
the third wing support bracket is 6¾″ to 9¾ below the second wing support bracket,
the fourth wing support bracket is 6¾″ to 9¾″ below the third wing support bracket,
the fifth wing support bracket is 9¼″ to 12¼″ below the fourth wing support bracket,
the sixth wing support bracket is 16¾″ to 19¾″ below the fifth wing support bracket,
the seventh wing support bracket is 8¾″ to 11¾″ below the sixth wing support bracket, and above the floor baseplate,
a first product sample pivotably held by a wing support bracket, the first product sample having a height,
a second product sample pivotably held by a different wing support bracket than the bracket holding the first product sample, the second product sample having a different height than the height of the first product sample.

68. The display system of claim 67 wherein:
the attachment members along the outer edge of at least one of the wing support brackets comprise apertures.

69. The display system of claim 67 wherein:
the attachment members along the outer edge of at least one of the wing support brackets comprise pegs.

70. A display system for holding multiple product samples, comprising:
a floor base,
an upper structure,
a plurality of supports, each support comprising
an upper end and a lower end, each lower end being rigidly connected to the floor base and each upper end being connected to the upper structure,
a holder for a wing support bracket,
a wing support bracket comprising:
an inner edge, and outer edge, a first side edge and a second side edge, a top surface and a bottom surface,
a plurality of product sample connection means proximate the outer edge, each such connection means adapted to hold a product sample such that the product sample may pivot along a vertical axis extending perpendicularly from the connection means,
each of the first and second sides edge having a notch extending between the top and bottom surfaces and between the inner edge and outer edge and
sized to receive one of the plurality of vertical supports to hold the wing support bracket to the vertical support when the wing support bracket is horizontal, and
such that the wing support bracket may be tilted to a non-horizontal position to insert or remove the wing support bracket between the plurality of vertical supports.

71. The display system of claim 70 wherein the connection means of the wing support bracket comprises apertures extending between the top and bottom surfaces of the wing support bracket.

72. The display system of claim 70 wherein the connection means of the wing support bracket comprises pegs.

73. The display system of claim 70 wherein:
the plurality of supports comprise threaded shafts, and
the holders for the wing support brackets comprise nuts threaded on the threaded shafts.

74. A display system for holding multiple product samples, comprising:
a floor base,
an upper structure,
a plurality of supports, each support comprising
an upper end and a lower end, each lower end being rigidly connected to the floor base and each upper end connected to the upper structure,
a plurality of holders for wing support brackets,
first and second wing support brackets, each comprising:
an inner edge, and outer edge, a first side edge and a second side edge, a top surface and a bottom surface,
a plurality of product sample connection means proximate the outer edge, each such connection means adapted to hold a product sample such that the product sample may pivot along a vertical axis extending perpendicularly from the connection means,
and wherein
the number of product sample connection means of the first wing support bracket is different from the number of product sample connection means of the second wing support bracket,
the inner edge of the first wing support bracket comprises one or more inwardly extending cutouts,
the inner edge of the second wing support bracket comprises one or more inwardly extending cutouts, and
wherein the number of cutouts of the first wing support bracket is different than the number of cutouts of the second wing support bracket.

75. The display system of claim 74 wherein the connection means of the wing support bracket comprises apertures extending between the top and bottom surfaces of the wing support bracket.

76. The display system of claim 74 wherein the connection means of the wing support bracket comprises pegs.

77. A display system for holding multiple product samples, comprising:
a floor base,
an upper plate,
a plurality of supports, each support comprising
an upper end and a lower end, each lower end being rigidly connected to the floor base and each upper end connected to the upper plate,
a holder for a wing support bracket,
a plurality of deck board holder connection means each adapted to hold a deck board holder such that the deck board holder may pivot along a vertical axis extending perpendicularly from the connection means,
a deck board holder comprising:
an inner end and an outer end
the inner end being configured to be removably hold to a deck board holder connection means;
a middle structure extending between the inner and outer ends and having first and second opposing sides and further comprising:
a first tab configured to hold a deck board extending toward the first opposing side from the middle structure; and
a second tab configured to hold a deck board extending toward the second opposing side from the middle structure.

78. The display system of claim 77 wherein the deck board holder is pivotally mountable to the wing support bracket.

79. The display system of claim 78 wherein the inner end of the deck board holder comprises a downwardly extending peg adapted to engage an aperture in the deck board connection means within which the peg may pivot.

80. The display system of claim 78 wherein the inner end comprises a downwardly extending recess adapted to receive a deck board connection means peg such that the recess may pivot about the peg.

81. The display system of claim 77 further comprising: a first product sample hanging from the first tab, and
a second product sample hanging from the second tab.

81. The display system of claim 76 wherein:
the deck board holder is formed from a plate having opposing sides,
the first tab is bent from the plate toward the first opposing side; and
the second tab is bent from the plate toward the second opposing side.

82. The display system of claim 81 wherein:
the middle structure comprises an upper portion and a lower portion, and
the first and second tabs extend from the lower portion.

83. A product display system, comprising:
a column of wing support brackets comprising:
two shafts, each shaft comprising a first threaded end;
a plurality of wing support brackets, each wing support bracket being rigidly affixed to each of the two shafts;
each shaft comprising a threaded nut on the first treaded end;
a first plate comprising:
a plurality of teardrop-shaped holes, each teardrop-shaped hole comprising a wide end and a narrow end, the wide end sized to permit the nut on one of the first threaded ends to pass through the wide end, and the narrow end being sized to prevent the nut from passing through the narrow end,
such that the two first threaded ends of the two shafts may be simultaneously passed through the wide ends of the plurality of teardrop-shaped holes and moved so the two shafts abut the narrow ends of the plurality of teardrop-shaped holes, such that the nuts on the first threaded end may be tightened to secure the column of wing support brackets to the first plate.

84. The product display system of claim 83, wherein each of the two shafts further comprises a second threaded end, and each shaft comprising a threaded nut on the second threaded end,
and further comprising:
a second plate comprising:
a plurality of teardrop-shaped holes, each teardrop-shaped hole comprising a wide end and a narrow end, the wide end sized to permit the nut on one of the second threaded ends to pass through the wide end, and the narrow end being sized to prevent the nut from passing through the narrow end,
such that the two second threaded ends of the two shafts may be simultaneously passed through the wide ends of the plurality of teardrop-shaped holes of the second plate and moved so the two shafts abut the narrow ends of the plurality of teardrop-shaped holes, such that the nuts on the second threaded ends may be tightened to secure the column of wing support brackets to the second plate.

85. The product display system of claim 83, wherein each shaft comprises:
a tube and
wherein each threaded end comprises a threaded shaft extending from the tube.
